(19) United States
(12) Patent Application Publication
(10) Pub. No.: US 2025/0264125 A1
(43) Pub. Date: Aug. 21, 2025

(54) FASTENER

(71) Applicant: Atlas Copco IAS UK Limited, Flintshire (GB)

(72) Inventors: Paul Briskham, Flintshire (GB); Lewis Jepps, Flintshire (GB)

(21) Appl. No.: 18/863,165

(22) PCT Filed: May 3, 2023
(86) PCT No.: PCT/GB2023/051170

§ 371 Date: Nov. 5, 2024

(30) Foreign Application Priority Data
May 6, 2022 (GB) 2206685.6

(51) Int. Cl. F16B 25/00; F16B 25/10

(52) U.S. Cl. CPC F16B 25/0021; F16B 25/0084; F16B 25/106

(57) ABSTRACT

There is disclosed a hole forming and thread forming fastener (2). The hole forming and thread forming fastener (2) comprises a head (4) and a shank (10) that defines a longitudinal axis (L). The shank (10) comprises a shank section (12) and a tip section (14). The shank section (12) extends from the head (4). The tip section (14) extends from the shank section (12) and is opposed to the head (4). At least part of the shank section (12) is threaded. The tip section (14) is at least partially tapered and defines a tip angle (α). The tip angle (α) is at least 50 degrees.

### FIELD OF INVENTION

The present invention relates to a thread forming and hole forming fastener. The present invention also relates to methods of inserting a fastener into a workpiece and to a joint.

### BACKGROUND

Fasteners are used to connect components together. Fasteners may be used in isolation or in combination with other connection methods. Thread forming fasteners are a type of fastener that, rather than cutting material from a workpiece to create a thread, form the material of the workpiece such that a thread is created. No material, or a negligible amount of material, is removed from the workpiece when inserting a thread forming fastener. Some thread forming fasteners are also capable of forming a hole in the workpiece in which the fastener is disposed. The hole is formed simultaneously with the thread. Thread forming fasteners that can also form holes may be referred to as thread forming and hole forming fasteners.

To insert a thread forming and hole forming fastener into a workpiece, the fastener is rotated while in contact with the workpiece such that the workpiece is heated. The fastener is then inserted into the workpiece. The fastener, which is threaded, is rotated whilst it is being inserted into the workpiece. This forms a thread in the workpiece. The quality of the joint formed is a function of, among other factors, the amount of heat supplied to the workpiece.

It is an object of the present invention to obviate or at least mitigate the problems associated with known thread forming fasteners, whether identified herein or otherwise.

### SUMMARY

In a first aspect of the invention there is provided a hole forming and thread forming fastener. The hole forming and thread forming fastener comprises a head and a shank that defines a longitudinal axis. The shank comprises a shank section and a tip section. The shank section extends from the head, and the tip section extends from the shank section and is opposed to the head. At least part of the shank section is threaded. The tip section is at least partially tapered and defines a tip angle, the tip angle being at least 50 degrees.

Throughout this document, the term ‘tip angle’ may be understood to refer to the internal angle of the tip of the fastener. The tip angle may be understood to refer to the maximum angle between two tangents that extend through diametrically opposed points of the tip section.

The shank section may be a cylindrical shank section. The entire shank section may be threaded. The tip section may merge into the shank section by virtue of a radius or chamfer.

The tip angle may be not 118 degrees.

In use, the hole forming and thread forming fastener is rotated on a surface of a workpiece so as to heat the workpiece. Once the workpiece has been heated by a predetermined amount, the fastener is threaded into the workpiece by moving the fastener relative to the workpiece in a direction that is parallel to the longitudinal axis of the fastener. Rotation of the fastener continues while the fastener is being threaded into the workpiece. While the fastener is being threaded into the workpiece, the workpiece material forms around the threads of the shank section, thereby threading the fastener into the workpiece. The quality of the joint created using the fastener is a function of the amount by which the workpiece is heated during insertion of the fastener. Under-heating of the workpiece during the insertion process produces a sub-optimal joint. For example, under-heating of the workpiece during the insertion process may result in separation of the layers of the workpiece (where the workpiece comprises multiple layers), and/or inadequate engagement between the threads of the fastener and the workpiece material. Separation of the layers of the workpiece may also be referred to as gapping.

Since the tip angle of the tip section is at least 50 degrees, the likelihood of under-heating of a workpiece occurring while inserting the fastener into a workpiece is advantageously reduced. This is at least partly because of the contact area between the tip section and the workpiece that results from a tip angle of at least 50 degrees. Since the likelihood of under-heating of a workpiece occurring while inserting the fastener is reduced, the quality of the joint created using the fastener is improved relative to where a workpiece is under-heated during insertion of a fastener.

The tip angle may be at least 70 degrees (for example when no bore is provided in the tip).

Where the tip angle is at least 70 degrees, the likelihood of under-heating of a workpiece occurring is advantageously further reduced.

The tip section may define a tip section length. The shank section may define a shank section diameter. A ratio of the tip section length to the shank section diameter may be less than or equal to 0.6.

The ratio of the tip section length to the shank section diameter may be less than or equal to 0.4.

The tip angle may be less than or equal to 160 degrees.

Overheating of the workpiece during the insertion process may also produce a sub-optimal joint. For example, overheating of the workpiece during the insertion process may result in separation of the layers of the workpiece (where the workpiece comprises multiple layers), and/or inadequate engagement between the threads of the fastener and the workpiece material.

The tip angle being less than or equal to 160 degrees reduces the likelihood of overheating of a workpiece occurring while inserting the fastener into a workpiece. This is at least partly as a result of the contact because of the contact area between the tip section and the workpiece that results from a tip angle of less than or equal to 160 degrees. Since the likelihood of overheating of a workpiece occurring while inserting the fastener is reduced, the quality of the joint created using the fastener is improved relative to where a workpiece is overheated during insertion of a fastener.

In addition, a tip angle of less than or equal to 160 degrees allows the workpiece material to pass around the fastener, instead of being pushed ahead of the fastener. Since the workpiece material is able to pass around the fastener, the likelihood of gapping occurring during insertion of the fastener into a workpiece is advantageously reduced.

The tip angle may be at least 125 degrees. The tip angle may be less than or equal to 135 degrees.

Where the tip angle is at least 125 degrees and less than or equal to 135 degrees, the likelihood over overheating or of under-heating is further reduced, thereby further improving the quality of the joint created using the fastener.

The tip angle may be 130 degrees.

The head may comprise an internal drive geometry. The head may comprise an external drive geometry. The head may comprise a one-way drive geometry. The head may comprise a frangible drive portion. The frangible drive portion may be separable from the fastener following insertion of the fastener into a workpiece.

The tip of the fastener may be conical. The tip of the fastener may be frustoconical. The tip of the fastener may be radiused.

The shank section may comprise a first shank portion that adjoins the head. The shank section may comprise a second shank portion that adjoins the tip section.

The shank section may comprise a base section. The first shank portion may comprise the base section.

The first shank portion may not threaded. The second shank portion may be threaded.

Where the first shank portion is not threaded, the resistance to insertion of the fastener is reduced relative to if the first shank portion were threaded. This reduces the magnitude of the force required to insert the fastener into a workpiece. Reducing the force required to insert the fastener into a workpiece advantageously reduces the magnitude of deflection exhibited by the workpiece during the fastener insertion process, which reduces the likelihood of gapping occurring. Therefore, where the first shank portion is not threaded and the second shank portion is threaded, a better quality joint is provided.

The first shank portion may be axisymmetric about the longitudinal axis.

The first shank portion may comprise one or more retaining features. In use, the one or more retaining features may engage a workpiece into which the hole forming and thread forming fastener is inserted.

The one or more retaining features may comprise one or more surface irregularities. The one or more surface irregularities may comprise a plurality of projections that project from the first shank portion. The plurality of projections may take the form of, for example, ribs and/or hemispheres. The ribs may extend around and/or along the longitudinal axis of the shank.

Where the first shank portion comprises one or more retaining features, the likelihood of the fastener loosening in use is advantageously reduced, thereby resulting in a more robust joint.

The diameter of the first shank portion may be greater than the diameter of the second shank portion.

The head may define an undercut.

When inserting the fastener into a workpiece, some of the workpiece material may be extruded out of the aperture formed by the workpiece in a direction that is opposed to the direction of insertion of the fastener. Where the head defines an undercut, this extruded material can advantageously be received by the undercut portion of the head. In the absence of an undercut, the extruded material can prevent full insertion of the fastener. Therefore, the undercut of the head allows full fastener insertion, thereby providing a more robust joint using the fastener.

The hole forming and thread forming fastener may further comprise a threaded stud that extends from a side of the head that is opposed to the underside.

Advantageously, a threaded stud allows a component to be affixed to the fastener, thereby making the fastener more versatile as compared to if the threaded stud were not present.

The tip section may define an undercut that is disposed adjacent the shank section.

Where the tip section comprises an undercut, the workpiece material deforms into the undercut during the fastener insertion process. This creates a further interlocked region between the fastener and the workpiece. The further interlocked region increases the strength of the connection between the fastener and the workpiece as compared to if the undercut were not provided. Therefore, the undercut allows a more robust joint to be created using the fastener.

The pitch diameter of the thread of the shank section may be constant along at least 90% of the length of the shank section.

The pitch diameter of the thread of the shank section may be constant along at least 75% of the length of the shank section. The pitch diameter of the thread of the shank section may be constant along the entire length of the shank section.

In a second aspect of the invention there is provided a method of inserting a fastener into a workpiece. The method comprises providing a fastener, the fastener being a fastener according to the first aspect of the invention, the fourth aspect of the invention, the fifth aspect of the invention or the sixth aspect of the invention. The method further comprises providing a workpiece. The workpiece comprising a first surface and a second surface. The second surface is opposed to the first surface. The method further comprises rotating the fastener about the longitudinal axis of the fastener and bringing the fastener into contact with the first surface of the workpiece so as to heat the workpiece. The method further comprises threading the fastener into the workpiece by moving the fastener and the workpiece relative to one another in a direction that is parallel to the longitudinal axis of the fastener such that the tip section of the fastener penetrates the first surface. The fastener does not penetrate the second surface of the workpiece.

The advantages discussed above in relation to the first aspect of the invention apply to the present aspect mutatis mutandis.

The first surface of the workpiece and the second surface of the workpiece need not form a part of the same material layer of the workpiece. The first surface may be referred to as an upper or top surface. The second surface may be referred to as a lower or bottom surface.

Threading the fastener into the workpiece may comprise forming a thread in the workpiece with the fastener.

The method may further comprise providing a die. While the fastener is being threaded into the workpiece, the second surface may engage the die. The method may comprise deforming workpiece material into the die. The workpiece material may be deformed into the die at the same time that the fastener is being threaded into the workpiece.

The method may be performed without using a die.

Where the second workpiece surface engages the die while the fastener is being threaded into the workpiece, the workpiece is advantageously better constrained compared to if the die were not present. The die is able to react the force used to thread the fastener into the workpiece, thereby resulting in reduced workpiece deflection as the fastener is being threaded into the workpiece, as compared to if the die were not provided. Workpiece deflection can, for example, cause gapping. In addition, since the force used to insert the fastener into the workpiece can be reacted by the die, the force used can be increased relative to where no die is provided. Therefore, providing a die that the second workpiece surface of the workpiece engages advantageously provides a better quality joint.

The die may comprise a die recess. While the fastener is being threaded into the workpiece, the second surface of the workpiece may deform into the die recess.

Where the second workpiece surface deforms into the die recess, the shape of the second surface of the workpiece can be controlled by virtue of the shape of the die.

The die recess may be configured such that the workpiece material does not completely fill the die upon completion of insertion of the fastener into the workpiece.

The die recess being configured such that the workpiece material does not completely fill the die upon completion of insertion of the fastener into the workpiece advantageously allows the die to be used with a variety of different workpiece materials. In addition, the likelihood of the workpiece becoming stuck to the workpiece is reduced.

The die recess may be in the form of a continuous groove or a continuous channel.

The die recess may define a die recess volume. A volume of workpiece material may be displaced while the fastener is being threaded into the workpiece. The die volume may be equal to or greater than the volume of workpiece material displaced.

The workpiece may comprise only a single workpiece layer.

The single workpiece layer may comprise both the first surface and the second surface of the workpiece.

The workpiece may comprise a first layer and a second layer.

The first layer of the workpiece may comprise the first surface of the workpiece. The second layer of the workpiece may comprise the second surface of the workpiece.

At least one of the layers of the workpiece may be made from a metallic material. At least one of the layers of the workpiece may be made from aluminium.

Both of the layers of the workpiece may be made from a metallic material. The first layer may be made from aluminium. The second layer may be made from aluminium. The first layer may be made from cast aluminium. The second layer may be made from sheet aluminium. The second layer may be made from cast aluminium. The first layer may be made from sheet aluminium.

The material of the workpiece may have a tensile strength of at least 300 MPa. The material of the workpiece may have a tensile strength of equal to or less than 550 MPa. The material of the workpiece may have a ductility, measured as percent elongation, of equal to or less than 10%. The material of the workpiece may have a ductility, measured as percent elongation, of equal to or less than 5%.

The first workpiece layer may comprise an aperture through which the fastener passes before contacting the workpiece.

Where the first workpiece layer comprises an aperture through which the fastener passes before contacting the workpiece, the second workpiece layer may comprise the first surface of the workpiece. A diameter of the aperture may be greater than a diameter of the threaded shank section of the thread forming and hole forming fastener.

When inserting the fastener into a workpiece, some of the workpiece material may be extruded out of the aperture formed by the workpiece in a direction that is opposed to the direction of insertion of the fastener. Where the first workpiece layer comprises an aperture through which the fastener passes before contacting the workpiece, this extruded material can advantageously be received between the fastener and the aperture. In the absence of an aperture, the extruded material can prevent full insertion of the fastener. Therefore, the undercut of the head allows full fastener insertion, thereby providing a more robust joint using the fastener.

Some materials may not be compatible with the fastener. This may be because, for example, the fastener is not able to sufficiently heat the material such that the fastener can be threaded into the material. Providing an aperture through the first workpiece layer through which the fastener passes before contacting the workpiece allows the fastener to connect workpiece layers of different materials, including materials that would otherwise be incompatible with the fastener. Therefore, the method is more versatile as compared to where no aperture is provided.

The first workpiece layer may be formed of a composite material.

The first layer may not be provided with an aperture through which the thread forming and hole forming fastener extends.

The fastener may comprise a threaded stud that extends from a side of the head that is opposed to the shank section of the shank. The method may further comprise securing a component to the threaded stud.

The rate at which the fastener is rotated relative to the workpiece may be reduced at least once while the fastener is being threaded into the workpiece.

The rate at which the fastener is rotated relative to the workpiece following the reduction may be a non-zero value.

Reducing the rate at which the fastener is rotated relative to the workpiece allows the workpiece material to better form around the fastener. Therefore, where the rate at which the fastener is rotated relative to the workpiece is reduced while the fastener is being threaded into the workpiece, the strength of the connection between the fastener and the workpiece is advantageously improved.

The reduction of the rate at which the fastener is rotated relative to the workpiece may occur while the tip section is disposed in the second workpiece layer.

The rate at which the fastener is moved relative to the workpiece following the reduction may be a non-zero value. The reduction of rotational speed may occur when the tip section is at least 25% of the way through the second workpiece layer.

Reducing the rate at which the fastener is rotated relative to the workpiece allows the workpiece material to better form around the fastener. The majority of the connection strength between the fastener and the workpiece is as a result of the connection between the fastener and the second workpiece layer. Therefore, where the rate at which the fastener is rotated relative to the workpiece is reduced while the tip section of the fastener is disposed in the second workpiece layer, the strength of the connection between the fastener and the workpiece is advantageously further improved.

Following threading the fastener into the workpiece, the second surface of the workpiece may comprise a protrusion in which at least part of the tip section of the shank of the fastener is received.

In a third aspect of the invention there is provided a joint. The joint comprises a workpiece comprising a first surface and a second surface. The joint further comprises a fastener according to the first aspect of the invention, the fourth aspect of the invention, the fifth aspect of the invention or the sixth aspect of the invention. The fastener extends through the first surface and does not penetrate the second surface.

The workpiece may comprise a first workpiece layer. The first workpiece layer may comprise the first surface of the workpiece. The workpiece may comprise a second workpiece layer. The second workpiece layer may comprise the second surface of the workpiece. The fastener may at least partially penetrate the second workpiece layer. The fastener may only partially penetrate the second workpiece layer.

The fastener may be removable from the workpiece. The fastener may not be removable from the workpiece.

The advantages discussed above in relation to the first aspect of the invention apply to the present aspect mutatis mutandis.

The workpiece may comprise a first workpiece layer that comprises the first surface and a second workpiece layer that comprises the second surface.

The first workpiece layer may comprise an aperture through which the thread forming and hole forming fastener extends.

A diameter of the aperture may be greater than a diameter of the threaded shank section of the thread forming and hole forming fastener.

The first workpiece layer may be formed of a composite material.

The first layer may not be provided with an aperture through which the thread forming and hole forming fastener extends.

The workpiece may comprise only a single workpiece layer.

The thread forming and hole forming fastener may further comprise a threaded stud that extends from a side of the head that is opposed to the shank section.

At least one of the workpiece layers may be made from a metallic material. At least one of the layers of the workpiece may be made from aluminium.

Both of the workpiece layers may be made from a metallic material. The first workpiece layer may be made from aluminium. The second workpiece layer may be made from aluminium. Both of the workpiece layers may be made from aluminium. The first workpiece layer may be made from cast aluminium. The second workpiece layer may be made from sheet aluminium. The second layer may be made from cast aluminium. The first layer may be made from sheet aluminium.

The material of the workpiece may have a tensile strength of at least 300 MPa. The material of the workpiece may have a tensile strength of equal to or less than 550 MPa. The material of the workpiece may have a ductility, measured as percent elongation, of equal to or less than 10%. The material of the workpiece may have a ductility, measured as percent elongation, of equal to or less than 5%.

The head of the thread forming and hole forming fastener may be disposed proud of the workpiece. The head of the thread forming and hole forming fastener may be disposed substantially flush with the workpiece.

The second surface may comprise a protrusion in which the tip section of the fastener is at least partially received.

In a fourth aspect of the invention there is provided a hole forming and thread forming fastener. The hole forming and thread forming fastener comprises a head and a shank that defines a longitudinal axis. The shank comprises a cylindrical shank section. The shank comprises a tip section. The cylindrical shank section extends from the head. The tip section extends from the cylindrical shank section. The tip section is opposed to the head. At least part of the cylindrical shank section is threaded. The fastener further comprises a bore that extends into the tip section and at least part way along the longitudinal axis.

The term ‘thread forming fastener’ is a known term in the art and refers to a fastener that, instead of cutting a thread in a workpiece, forms a thread by deforming the workpiece material.

The bore may extend from a tip of the tip section and along the longitudinal axis. The bore may be a through bore. The term ‘through bore’ may be understood to refer to a bore that extends along the whole length of the fastener. The bore may be cylindrical. The bore may be a blind bore.

The entire shank section may be threaded.

In the process of inserting a hole forming and thread forming fastener into a workpiece, at least some of the material of the workpiece is displaced by the fastener. The displaced material protrudes from one or more of an upper surface of the workpiece (i.e. the surface into which the fastener is inserted), a lower surface of the workpiece (i.e., the surface opposed to the surface of insertion) and one or more intermediate surfaces (i.e., the surfaces at an interface between workpiece layers). This can result in joint defects such as separation of the workpiece layers, and impartial insertion of the fastener due to interference with the protruded material. Such defects impair the quality of the joint created.

Since the fastener comprises a bore, at least some of the workpiece material is received by the bore during and following insertion of the fastener into a workpiece. Therefore, the amount of material displaced by the fastener during insertion is reduced relative to where a bore is not provided, thereby reducing the likelihood of material protruding. This advantageously improves joint quality relative to where a bore is not provided.

The tip section may define a ring leading edge.

The ring leading edge may define a ring surface.

Where the tip section defines a ring leading edge, during the process of inserting the fastener into a workpiece, the initial contact area between the tip section and the workpiece is greater than if, for example, the tip section defined a pointed tip. This increase in contact area advantageously heats the workpiece quicker compared to a smaller contact area, thereby making the fastener insertion process quicker.

In addition, during the fastener insertion process, the contact area between the ring leading edge and the workpiece is further away from the axis of rotation of the fastener than a fastener that comprises a pointed tip section. Because of this, the velocity of the ring leading edge is greater than the tip of a pointed tip section for the same rotational velocity. This increases the heat that is supplied to the workpiece during the fastener insertion process, thereby heating the workpiece quicker compared to a fastener with, for example, a pointed tip section.

The ring leading edge may be non-coplanar.

The ring leading edge being non-coplanar may be understood to mean that at least part of the ring leading edge does not lie in the same plane as another part of the ring leading edge.

The ring leading edge may comprise a plurality of facets such that the ring leading edge is serrated.

Since the ring leading edge is non-coplanar, the amount of friction generated while inserting the fastener into a workpiece is increased. This reduces the likelihood that the workpiece is under-heated during the fastener insertion process.

The bore may define a bore internal diameter. The bore may define a tapered surface section. The ring leading edge may merge into the bore internal diameter via the tapered surface section.

The diameter of the ring leading edge may be greater than the diameter of the bore internal diameter. The tapered surface section may comprise a chamfered surface section and/or a radiused surface section.

The bore may define a bore depth. The tapered surface section may define a tapered surface section depth. The ratio of the tapered surface section depth to the bore depth may be at least 0.1. The ratio of the tapered surface section depth to the bore depth may be at least 0.25. The ratio of the tapered surface section depth to the bore depth may be at least 0.5.

Since the ring leading edge merges into the bore internal diameter by means of a tapered surface section, the stress exerted on the fastener both during the fastener insertion process and in use is more evenly distributed as compared to alternative transition surfaces between the ring leading edge and the bore internal diameter. More even stress distribution reduces the likelihood of fastener failure as a result of, for example, the fastener cracking.

The bore may define a bore internal diameter. The cylindrical shank section may define a shank diameter. A ratio of the shank diameter to the bore internal diameter may be at least 1.5.

This ratio of shank diameter to bore internal diameter advantageously provides sufficient shank material such that the fastener is able to withstand the forces required in use, thereby making the fastener more robust.

The ratio of the shank diameter to the bore internal diameter may be at least 2.

The shank may define a shank length. The bore may extend along at least 25% of the shank length.

Where the bore extends along at least 25% of the shank length, the amount of workpiece material that can be accommodated by the bore is sufficient such that the likelihood of gapping occurring during the fastener insertion process is sufficiently reduced.

The bore may extend along at least 50% of the shank length.

The bore may extend along up to 25% of the shank length. The bore may extend along up to 10% of the shank length.

A shallower bore may be desirable for thinner workpieces. Less workpiece material is displaced by the fastener for thinner workpieces because there is less workpiece material to be displaced. The depth of the bore may therefore be chosen based on the thickness of the workpiece. A shallower bore may also be used for harder and/or stronger workpieces. This is because the likelihood of fastener deformation occurring during fastener insertion increases with increasing workpiece hardness and strength. Therefore, a bore that extends along up to 25%, or up to 10%, of the shank length provides the benefits of increasing the heat supplied to the workpiece, discussed above, while reducing the likelihood of fastener deformation.

The bore may defines a bore surface. The bore surface may defines a plurality of surface irregularities.

Where the bore defines a plurality of surface irregularities, the surface irregularities interlock with a workpiece into which the fastener has been inserted. This advantageously improves the strength of the connection between the fastener and a workpiece.

The entirety of the bore may be cylindrical.

Where the entirety of the bore is cylindrical, the strength of the shank of the fastener is improved relative to a bore that includes a tapered section.

In a fifth aspect of the invention there is provided a hole forming and thread forming fastener. The hole forming and thread forming fastener comprises a head and a shank that defines a longitudinal axis. The shank comprises a shank section. The shank comprises a tip section. The shank section extends from the head. The tip section extends from the shank section. The tip section is opposed to the head. At least part of the shank section is threaded. The shank section defines a shank section length. The tip section defines a tip section length. A ratio of the shank section length to the tip section length is at least 2.5. The tip section comprises a plurality of surface irregularities.

The ratio of the shank section length to the tip section length may be calculated by dividing the shank section length by the tip section length.

The plurality of surface irregularities may be in the form of a plurality of facets.

The plurality of surface irregularities may be in the form of a plurality of ribs.

The plurality of surface irregularities may be in the form of a plurality of facets and a plurality of ribs.

The plurality of facets may comprise at least three facets. The facets may each be in the form of a radiused surface section. The facets may adjoin one another. The facets may be arranged as an array. The facets may be spaced apart from one another.

The plurality of ribs may comprise at least two ribs. The plurality of ribs may comprise at least three ribs. The plurality of ribs may comprise six ribs. A component of the length of the ribs may extend in a radial direction (i.e., perpendicular to a longitudinal axis of the fastener). A component of the length of the ribs may extend in a circumferential direction (i.e., about the longitudinal axis of the fastener). The ribs may extend radially outwardly from a tip of the tip section. A thickness and/or width of the ribs may be either uniform or non-uniform. The thickness of the ribs may be understood to refer to the distance by which they protrude from a surface of the tip section. The thickness and/or width of the ribs may be at a minimum at or adjacent to the tip of the tip section. The thickness and/or width of the ribs may be at a maximum at or adjacent to the tip of the tip section.

The tip section may be a tapered tip section. The shank section may be cylindrical. The entire shank section may be threaded.

Each facet of the plurality of facets, or each rib of the plurality of ribs, may extend from a tip of the tip section towards the shank section. Each facet of the plurality of facets, or each rib of the plurality of ribs, may extend from a tip of the tip section to the shank section. Each facet of the plurality of facets may extend radially outwardly from a tip of the tip section.

In use, the hole forming and thread forming fastener is rotated on a surface of a workpiece so as to heat the workpiece. Once the workpiece has been heated by a predetermined amount, the fastener is threaded into the workpiece by moving the fastener relative to the workpiece in a direction that is parallel to the longitudinal axis of the fastener. Rotation of the fastener continues while the fastener is being threaded into the workpiece. While the fastener is being threaded into the workpiece, the workpiece material forms around the threads of the shank section, thereby threading the fastener into the workpiece. The quality of the joint created using the fastener is a function of the amount by which the workpiece is heated during insertion of the fastener. Under-heating of the workpiece during the insertion process produces a sub-optimal joint. For example, under-heating of the workpiece during the insertion process may result in separation of the layers of the workpiece (where the workpiece comprises multiple layers), and/or inadequate engagement between the threads of the fastener and the workpiece material. Separation of the layers of the workpiece may also be referred to as gapping.

Since the tip section comprises a plurality of surface irregularities, the likelihood of under-heating of a workpiece occurring while inserting the fastener into a workpiece is advantageously reduced. The plurality of surface irregularities provide the tip section with a discontinuous profile. The discontinuous profile increases the amount of friction between the tip section of the fastener of the workpiece, thereby increasing the amount of heat generated during the fastener insertion process. Since the likelihood of under-heating of a workpiece occurring while inserting the fastener is reduced, the quality of the joint created using the fastener is improved relative to where a workpiece is under-heated during insertion of a fastener.

The plurality of facets may comprise six facets.

Where the plurality of facets comprises six facets, the heating of the workpiece during insertion of the fastener is optimised.

The plurality of facets may comprise at least two facets. The plurality of facets may comprise at least four facets.

The facets may each be in the form of a planar surface section. The facets may adjoin one another. The facets may be spaced apart from one another.

In a sixth aspect of the invention there is provided a hole forming and thread forming fastener. The hole forming and thread forming fastener comprises a head and a shank that defines a longitudinal axis. The shank comprises a shank section. The shank comprises a tip section. The shank section extends from the head. The tip section extends from the shank section. The tip section is opposed to the head. At least part of the shank section is threaded.

Any features disclosed with respect to the first, fourth or fifth aspects of the invention may be combined with the sixth aspect of the invention.

In a seventh aspect of the invention there is provided a method of inserting a fastener into a workpiece. The method comprises providing a workpiece that comprises a first workpiece layer and a second workpiece layer. The method further comprises applying an adhesive to the first and/or second workpiece layers. The method further comprises bringing the first workpiece and the second workpiece into engagement with one another such that the adhesive is disposed between the first workpiece layer and the second workpiece layer. The method further comprises providing a fastener. The fastener comprising a head and a shank. The shank defines a longitudinal axis The shank comprises a shank section. The shank comprises a tip section. At least part of the shank section is threaded. The shank section extends from the head. The tip section extends from the shank section and is opposed to the head. The method further comprises rotating the fastener about the longitudinal axis and bringing the fastener into contact with the workpiece so as to heat the workpiece. The method further comprises threading the fastener into the workpiece by moving the fastener and the workpiece relative to one another in a direction that is parallel to the longitudinal axis such that the tip section of the fastener penetrates through the first workpiece layer and through the adhesive. The fastener at least partially penetrates the second workpiece layer.

Since an adhesive layer is provided, the strength of the connection between the first workpiece and the second workpiece is advantageously greater than if the adhesive were not present.

The fastener may be a fastener according to the first, fourth, fifth or sixth aspect of the invention.

The fastener may only partially penetrate the second workpiece layer.

Where the fastener only partially penetrates the second workpiece layer the likelihood of ingress of fluid via the second layer is reduced. Reducing the likelihood of fluid ingress is desirable because the presence of fluid can cause joint defects, such as oxidisation. Therefore, the fastener only partially penetrating the second workpiece layer advantageously provides a more robust joint.

In addition, where the fastener only partially penetrates the second workpiece layer, the tip section of the fastener is disposed within the second workpiece layer, and does not protrude out of the workpiece. This is desirable because a protruding fastener provides a risk of injury to a user and/or damage to a component. Therefore, the fastener only partially penetrating the second workpiece layer advantageously provides a safer joint.

In an eighth aspect of the invention there is provided a method for inserting a fastener into a workpiece. The method comprises providing a fastener. The fastener comprises a head and a shank. The shank defines a longitudinal axis. The shank comprises a shank section and a tip section. The shank section is at least partially threaded. The threaded shank section extends from the head. The tip section extends from the shank section and is opposed to the head. The method further comprises providing a workpiece. The workpiece comprises a first surface and a second surface. The second surface is opposed to the first surface. The method further comprises rotating the fastener about the longitudinal axis and bringing the fastener into contact with the first surface of the workpiece so as to heat the workpiece. The method further comprises moving the fastener relative to the workpiece at a rate of at least 0.5 mm/sec. The fastener is moved in a direction that is parallel to the longitudinal axis of the fastener such that the tip section penetrates the first surface of the workpiece and such that the fastener is threaded into the workpiece. The fastener does not penetrate the second surface of the workpiece.

The first surface of the workpiece and the second surface of the workpiece need not form a part of the same material layer of the workpiece. The first surface may be referred to as an upper or top surface. The second surface may be referred to as a lower or bottom surface.

The threaded shank may be cylindrical.

Since the fastener is moved relative to the workpiece at a rate of at least 0.5 mm/sec in a direction that is parallel to the longitudinal axis of the fastener, the likelihood of overheating of the workpiece occurring is reduced. This is because the rate at which the fastener is inserted into the workpiece is sufficient such that the fastener insertion process can be completed before workpiece overheating occurs. Reducing the likelihood of overheating of the workpiece is desirable because overheating can result in joint defects, such as gapping. Therefore, moving the fastener relative to the workpiece at a rate of at least 0.5 mm/sec in a direction that is parallel to the longitudinal axis of the fastener advantageously produces a better quality joint relative to if the fastener were moved at a rate slower than 0.5 mm/sec.

In addition, since the fastener does not penetrate the second surface of the workpiece the likelihood of ingress of fluid via the second layer is reduced. Reducing the likelihood of fluid ingress is desirable because the presence of fluid can cause joint defects, such as oxidisation. Therefore, the fastener only partially penetrating the second workpiece layer advantageously provides a more robust joint.

In addition, since the fastener does not penetrate the second surface of the workpiece, the tip section of the fastener is disposed within the workpiece, and does not protrude out of the workpiece. This is desirable because a protruding fastener provides a risk of injury to a user and/or damage to a component. Therefore, the fastener not penetrating the second surface of the workpiece advantageously provides a safer joint.

The rate at which the fastener is moved relative to the workpiece may be reduced at least once while the fastener is being threaded into the workpiece.

The rate at which the fastener is moved relative to the workpiece following the reduction may be a non-zero value.

Reducing the rate at which the fastener is moved relative to the workpiece allows the workpiece material to better form around the fastener. Therefore, where the rate at which the fastener is moved relative to the workpiece is reduced while the fastener is being threaded into the workpiece, the strength of the connection between the fastener and the workpiece is advantageously improved.

The workpiece may comprise a first workpiece layer and a second workpiece layer. The first workpiece layer may comprise the first surface of the workpiece. The second workpiece layer may comprise the second surface of the workpiece. The rate at which the fastener is moved relative to the workpiece may be reduced while the tip section of the fastener is disposed in the second workpiece layer.

The rate at which the fastener is moved relative to the workpiece following the reduction may be a non-zero value.

Reducing the rate at which the fastener is moved relative to the workpiece allows the workpiece material to better form around the fastener. The majority of the connection strength between the fastener and the workpiece is as a result of the connection between the fastener and the second workpiece layer. Therefore, where the rate at which the fastener is moved relative to the workpiece is reduced while the tip section of the fastener is disposed in the second workpiece layer, the strength of the connection between the fastener and the workpiece is advantageously further improved.

The fastener may be moved relative to the workpiece in a direction that is parallel with the longitudinal axis of the fastener at a rate of at least 1 mm/sec.

The fastener may be moved relative to the workpiece in a direction that is parallel with the longitudinal axis of the fastener at a rate of at least 2 mm/sec.

In a ninth aspect of the invention there is provided a method for inserting a fastener into a workpiece. The method comprises providing a fastener. The fastener comprises a head and a shank. The shank defines a longitudinal axis. The shank comprises a shank section and a tip section. The shank section is at least partially threaded. The threaded shank section extends from the head. The tip section extends from the shank section and is opposed to the head. The method further comprises providing a workpiece. The workpiece comprises a first surface and a second surface. The second surface is opposed to the first surface. The method further comprises rotating the fastener about the longitudinal axis and bringing the fastener into contact with the first surface of the workpiece so as to heat the workpiece. The method further comprises threading the fastener into the workpiece by moving the fastener and the workpiece relative to one another in a direction that is parallel to the longitudinal axis such that the tip of the fastener penetrates through the first surface of the workpiece. The fastener does not penetrate the second surface of the workpiece. Throughout the method, the workpiece temperature remains below a recrystallisation temperature of the workpiece material.

The threaded shank section may be cylindrical.

Since the workpiece temperature remains below the recrystallisation temperature of the workpiece material throughout the method, the fastener is able to better form the threads in the workpiece as compared to if the workpiece temperature were to exceed the recrystallisation temperature of the workpiece material. This is because below the recrystallisation temperature, the ductility of the workpiece material is optimised for the fastener to form the threads. Above the recrystallisation temperature of the material, the ductility of the workpiece material is too great for threads to be correctly formed. Since the threads are better formed, the strength of the connection between the fastener and the workpiece is improved.

The workpiece may comprise a first workpiece layer and a second workpiece layer. Throughout the method, the material of the first workpiece layer may not mix with the material of the second workpiece layer.

In a tenth aspect of the invention there is provided a joint. The joint comprises a workpiece. The workpiece comprises a first workpiece layer and a second workpiece layer. The joint further comprises an adhesive layer that is disposed between the first workpiece layer and the second workpiece layer. The joint further comprises a fastener that has formed a hole and a thread in the workpiece. The fastener extends through the first workpiece layer, the adhesive layer, and at least partially through the second workpiece layer.

The fastener may extend only partially through the second workpiece layer. The fastener may be threaded into the first workpiece layer. The fastener may be threaded into the second workpiece layer.

The fastener may be threaded into all of the layers of the workpiece. The fastener may be removable from the workpiece. The fastener may not be removable from the workpiece.

In an eleventh aspect of the invention there is provided a joint. The joint comprises a workpiece. The workpiece comprises a first surface and a second surface. The joint further comprises a hole forming and thread forming fastener. The hole forming and thread forming fastener comprises a head and a shank. The shank comprises a shank section. The shank comprise a tip section. At least part of the shank section is threaded. The shank section extends from the head. The tip section extends from the shank section. The tip section is opposed to the head. The fastener extends through the first surface. The fastener does not penetrate the second surface. The workpiece further comprises a thermomechanically affected zone adjacent an interface between the workpiece and the thread forming and hole forming fastener.

The workpiece material in the region of the thermomechanically affected zone is harder than the remainder of the workpiece material. Harder workpiece material provides improved connection strength compared to softer workpiece material. Harder workpiece material in the region of the thermomechanically affected zone also improves the ability of the joint to undergo fatigue loading without failing.

The workpiece may comprise a first workpiece layer. The first workpiece layer may comprise the first surface of the workpiece. The workpiece may comprise a second workpiece layer. The second workpiece layer may comprise the second surface of the workpiece. The fastener may at least partially penetrate the second workpiece layer. The fastener may only partially penetrate the second workpiece layer.

The workpiece may not comprise a stirred zone. The fastener may be removable from the workpiece. The fastener may not be removable from the workpiece.

The threaded shank section may be a cylindrical threaded shank section.

In a twelfth aspect of the invention there is provided a joint. The joint comprises a workpiece. The workpiece comprises only a single workpiece layer. The workpiece layer comprises a first surface and a second surface. The joint further comprises a hole forming and thread forming fastener. The hole forming and thread forming fastener comprises a head and a shank. The shank comprises a shank section. The shank comprises a tip section. The shank section extends from the head. The shank section is at least partially threaded. The tip section extends from the shank section and is opposed to the head. The fastener extends through the first surface and does not extend through the second surface.

The shank section may be a cylindrical shank section. The fastener may be removable from the workpiece. The fastener may not be removable from the workpiece.

In a thirteenth aspect of the invention there is provided a hole forming and thread forming fastener. The hole forming and thread forming fastener comprises a head and a shank that defines a longitudinal axis. The shank comprises a shank section. The shank comprises a tip section. The shank section extends from the head. The tip section extends from the shank section. The tip section is opposed to the head. At least part of the shank section is threaded. The head is provided with a cutting edge.

When inserting the fastener into a workpiece to form a joint, workpiece material can be extruded from the workpiece in a direction that is opposed to the direction that the fastener is being inserted into the workpiece. This is undesirable as the extruded material is susceptible to corrosion, which can lead to joint failure. Advantageously, the cutting feature is able to remove any extruded workpiece material from the workpiece.

The extruded material may be referred to as excess material.

The cutting feature may be provided to an underside of the head. The cutting feature may be provided to a circumferential periphery of the head.

The cutting feature may be in the form of one or more ribs. The one or more ribs may comprise six ribs.

A component of the length of the ribs of the one or more ribs may extend in the radial direction. A component of the length of the ribs of the one or more ribs may extend in the longitudinal direction.

The cutting feature may be in the form of one or more teeth. The one or more teeth may comprise four teeth. At least part of each tooth of the plurality of teeth may extend in the radial direction. The one or more teeth may form a part of a radially peripheral surface of the head.

The one or more teeth may extend from an underside of the head towards a top of the head. The one or more teeth may extend from an underside of the head to the top of the head.

In a fourteenth aspect of the invention there is provided a method for inserting a fastener into a workpiece. The method comprises providing a fastener according to the thirteenth aspect of the invention. The method further comprises providing a workpiece, the workpiece comprising a first surface and a second surface. The second surface is opposed to the first surface. The method further comprises rotating the fastener about the longitudinal axis of the fastener and bringing the fastener into contact with the first surface of the workpiece so as to heat the workpiece. The method further comprises threading the fastener into the workpiece by moving the fastener and the workpiece relative to one another in a first direction, the first direction being parallel to the longitudinal axis of the fastener. The method further comprises extruding at least some workpiece material from the workpiece in a second direction, the second direction being generally opposed to the first direction. The method further comprises removing the extruded material from the workpiece using the cutting edge of the head of the fastener.

Features disclosed with respect to one aspect of the invention may be combined with features of another aspect of the invention. For example, features of any of the first, fourth and/or fifth aspects of the invention may be combined with the sixth aspect of the invention.

### BRIEF DESCRIPTION OF THE DRAWINGS

Embodiments of the present invention will now be described with reference to the accompanying drawings, in which:

FIG. 1a shows a cross-sectional side view of a fastener in accordance with an embodiment of the present invention;

FIG. 1b shows a perspective view of the fastener of FIG. 1a;

FIG. 2 shows a fastener insertion apparatus for use with any of the depicted fasteners;

FIG. 3 shows an enlarged view of a nosepiece of the fastener insertion apparatus of FIG. 2;

FIG. 4 shows the nose piece of the fastener insertion apparatus of FIG. 2 during a fastener insertion process;

FIG. 5 shows a joint formed using the fastener of FIG. 1 and the fastener insertion apparatus of FIG. 2;

FIG. 6 shows a joint with a die of a fastener insertion apparatus;

FIG. 7a shows a bottom view of a fastener according to a further embodiment of the present invention;

FIG. 7b shows a cross-sectional side view of the fastener of FIG. 7a;

FIG. 8 shows a cross-sectional view of a fastener according to a further embodiment of the present invention;

FIG. 9 shows a joint formed using the fastener of FIG. 8;

FIG. 10 shows a cross-sectional view of a fastener according to a further embodiment of the present invention;

FIG. 11 shows a cross-sectional view of a joint formed using a fastener according to a further embodiment of the present invention;

FIG. 12 shows a cross-sectional view of a joint formed using a fastener according to a further embodiment of the present invention;

FIG. 13 shows a cross-sectional view of a fastener according to a further embodiment of the present invention;

FIG. 14 shows a cross-sectional view of a joint formed using a fastener according to a further embodiment of the present invention;

FIG. 15 shows a cross-sectional view of a fastener according to a further embodiment of the present invention;

FIG. 16 shows a cross-sectional view of a joint formed using a fastener according to a further embodiment of the present invention;

FIG. 17 shows a cross-sectional view of a joint formed using a fastener according to a further embodiment of the present invention;

FIG. 18 shows a cross-sectional view of a fastener according to a further embodiment of the present invention;

FIG. 19 shows a perspective view of a fastener according to a further embodiment of the present invention;

FIG. 20 shows a cross-sectional side view of a fastener according to a further embodiment of the present invention;

FIG. 21 shows a cross-sectional view of a joint formed using a fastener according to a further embodiment of the present invention;

FIG. 22 shows a cross-sectional side view of a fastener according to a further embodiment of the present invention;

FIG. 23 shows a cross-sectional side view of a fastener according to a further embodiment of the present invention;

FIG. 24 shows a fastener insertion apparatus for use with any of the fasteners disclosed herein;

FIG. 25 shows a detail view of the fastener insertion apparatus of FIG. 24;

FIG. 26 shows a joint with a die of a fastener insertion apparatus;

FIG. 27 shows a die for use with the fastener insertion apparatus of FIG. 2;

FIG. 28 a detail view of a fastener according to a further embodiment of the present invention;

FIG. 29 shows a cross-sectional view of a fastener and workpiece according to a further embodiment of the present invention;

FIG. 30 shows a cross-sectional view of a fastener and workpiece according to a further embodiment of the present invention;

FIG. 31 shows a fastener according to a further embodiment of the present invention;

FIG. 32 shows a fastener according to a further embodiment of the present invention;

FIG. 33 shows a fastener according to a further embodiment of the present invention;

FIG. 34 shows a nosepiece of a fastener insertion apparatus for use with any of the fasteners disclosed herein; and

FIG. 35 shows a side view of a fastener according to a further embodiment of the present invention.

### DETAILED DESCRIPTION

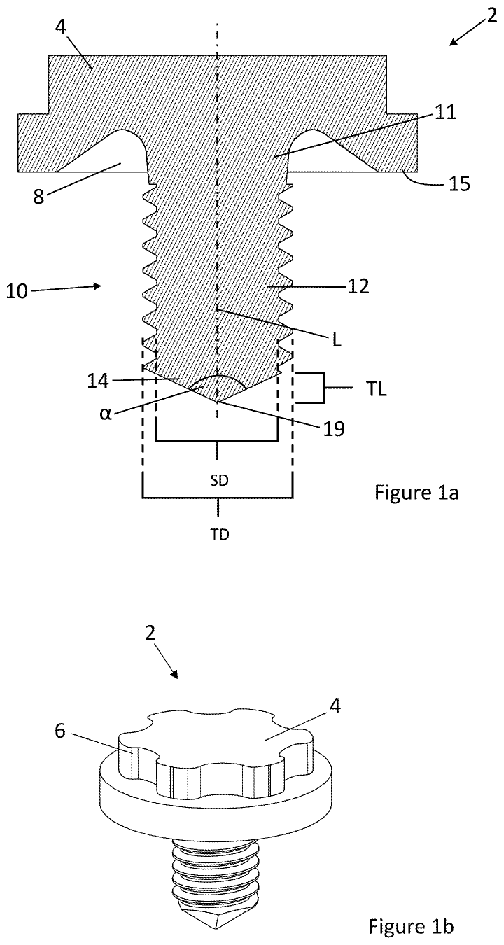

FIGS. 1a and 1b depict a fastener 2. The fastener 2 comprises a head 4. The head 4 comprises an underside 15. The fastener 2 comprises a shank 10. The shank 10 extends from the underside 15 of the head 4. The head 4 comprises a drive geometry 6, which can be seen in FIG. 1b. The periphery of the drive geometry 6 defines a discontinuous profile. In use, the drive geometry 6 is engaged by a fastener insertion apparatus, as will be discussed in more detail below. The drive geometry 6 is an external drive geometry. In some embodiments, the drive geometry 6 may be an internal drive geometry. In some embodiments, the drive geometry 6 may be a snap-off drive geometry.

The head 4 defines an undercut 8. The undercut 8 is disposed adjacent to and extends around the shank 10. The undercut 8 is able to receive material from a workpiece in use, as will be discussed in more detail below. In some embodiments, the undercut 8 need not be present. Where the undercut 8 is not present, the underside 15 of the head 4 may be generally planar.

The shank 10 comprises a shank section 12. The shank section 12 comprises a base section 11. The base section 11 of the shank section 12 extends from the head 4 of the fastener 2. The shank 10 comprises a tip section 14. The base section 11 is generally disposed within the undercut 8 of the head 4. However, in some embodiments, part of the base section 11 may extend beyond the underside 15 of the head 4. In such embodiments, the base section may taper towards the shank section 12 (as depicted). The shank section 10 defines a shank section diameter SD. The shank section diameter SD may be referred to as the minor diameter. The shank section diameter SD may exclude the diameter of the base section 11. The shank section diameter SD is determined by, for example, the required connection strength conferred by the fastener. The diameter of the shank section 10 may be at least 2 mm. The diameter of the shank section 12 may be less than or equal to 10 mm. The diameter of the shank section 12 may be at least 3 mm. The diameter of the shank section 12 may be less than or equal to 8 mm. The diameter of the shank section 12 may be 4 mm, such that the fastener 2 is an M4 fastener. The diameter of the shank section 12 may be 5 mm. The diameter of the shank section 12 need not be an integer. For example, the diameter of the shank section 12 may be 4.5 mm. The shank section 12 defines a longitudinal axis L.

The shank section 12 is threaded. The shank section 12 may therefore be referred to as a threaded shank section. The thread of the shank section 12 defines a thread diameter TD. The thread diameter TD may be referred to as the major diameter. The thread diameter TD is generally constant along the length of the shank section. In some embodiments, the thread diameter TD of the shank section 12 may be generally constant along at least 50% of the length of the shank section. In some embodiments, the thread diameter TD may be generally constant along at least 75% of the length of the shank section. In some embodiments, the thread diameter TD may be generally constant along at least 90% of the length of the shank section. In some embodiments, the thread of the shank section 12 may comprise a tapered section that adjoins the tip section 14. The shank section 12 is generally cylindrical. In FIG. 1a the entire shank section is shown as being threaded, however, in some embodiments at least part of the shank section 12 may be threaded. The fastener 2 may be made from any suitable material. For example, the fastener 2 may be made from steel. The fastener 2 may be provided with a coating. The coating may be, for example, a zinc nickel coating.

The tip section 14 extends from the shank section 12. In some embodiments, the tip section 14 may merge into the shank section 12 by virtue of a radius. In some embodiments, the tip section 14 may merge into the shank section 12 by virtue of a chamfer. The tip section 14 is disposed at an end of the shank section 12 that is opposed to the head 4. The tip section 14 defines a tip section length TL. In some embodiments, a ratio of the tip section length TL to the thread diameter TD of the shank section 12 may be less than or equal to 0.6. In some embodiments, a ratio of the tip section length TL to the thread diameter TD of the shank section 12 may be less than or equal to 0.4. The ratio of the tip section length TL to the thread diameter TD of the shank section 12 may be calculated by dividing the tip section length TL by the thread diameter TD. The ratio of the tip section length TL to the thread diameter TD may be selected based on, for example, the thickness of the workpiece, as a whole and/or of the individual layers of the workpiece. The ratio of the tip section length TL to thread diameter TD may be proportional to the workpiece thickness.

The tip section 14 is tapered. The tip section 14 defines a tip angle α. The term tip angle may be understood to refer to the internal angle of the tip of the tip section 14. The tip angle α is at least 50°. The tip angle α may be at least 70°. The tip angle α may be less than or equal to 160°. The tip angle α may be at least 125° and less than or equal to 135°. The tip angle α may be not 118°. In the depicted embodiment, the tip section 14 is conical. However, in other embodiments, the tip section 14 may be any other tapered shape, such as frustoconical or radiused. Where the tip section 14 is frustoconical, or any other tapered shape, the tip angle α is the angle between diametrically opposed points on the tapered surface of the tip section 14. Regardless of the shape of the tip section 14, the tip angle α is the maximum angle defined between two tangents that extend through diametrically opposed points of the tip section 14. The points through which the tangents extend being disposed at corresponding points along the longitudinal axis L. Where the tip section 14 is radiused, the tip section may be generally dome-shaped. Where the tip section 14 is dome-shaped, the dome may be a pointed dome. Where the tip section 14 is radiused, the radius of the tip section may be at least 2 mm. The radius of the tip section 14 may be equal to or less than 15 mm. The radius of the tip section 14 may be at least 5 mm. The radius of the tip section may be less than or equal to 10 mm. The tip section 14 defines a tip 19. The tip 19 defines an end point of the tip section 14. The tip 19 is in the form of a point. In other embodiments, for example where the tip section 14 is frustoconical, the tip 19 may be in the form of a flat surface section.

The fastener 2 is a hole forming and thread forming fastener. The term thread forming fastener is a term known in the art and refers to a fastener that, instead of cutting a thread in a workpiece, which removes workpiece material, forms a thread by deforming the workpiece material. The fastener 2 forms, rather than cuts, threads in a workpiece by virtue of the geometry of the threads of the shank section 12 and by virtue of the process by which the fastener is inserted into the workpiece, as will be discussed in more detail below. The term hole forming fastener is a term known in the art and refers to a fastener that, instead of cutting a hole in a workpiece, forms a hole by deforming the workpiece material.

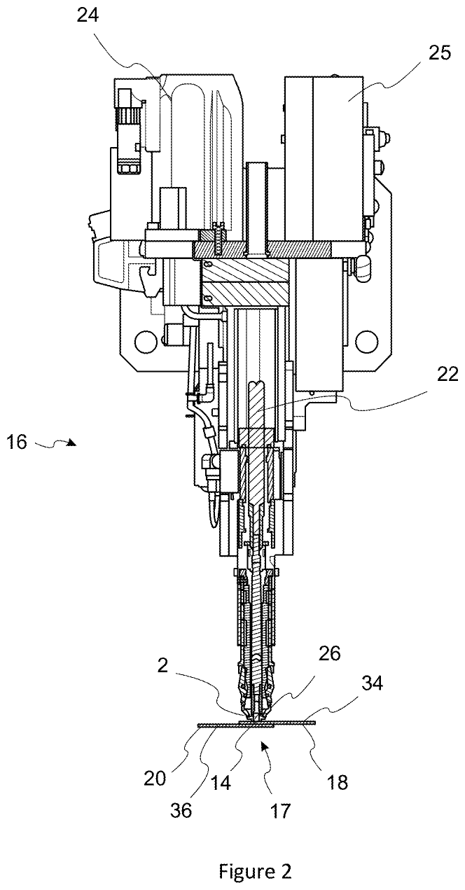

FIG. 2 shows an insertion apparatus 16 that is capable of inserting a fastener 2 into a workpiece 17. In some embodiments, the fastener 2 may be inserted into the workpiece 17 using a handheld fastener insertion apparatus. In FIG. 2, the workpiece 17 comprises a first workpiece layer 18 and a second workpiece layer 20. The first workpiece layer 18 may be referred to as the top layer of the workpiece 17. The second workpiece layer 20 may be referred to as the bottom layer of the workpiece 17. The first workpiece layer 18 defines a first surface 34 of the workpiece 17. The first surface 34 may be referred to as a top surface of the workpiece 17. The second workpiece layer 20 defines a second surface 36 of the workpiece 17. The second surface 36 of the workpiece 17 is opposed to the first surface 34 of the workpiece 17. The second surface 36 may be referred to as a bottom surface of the workpiece 17. In some embodiments, the workpiece 17 may comprise only a single workpiece layer. Where the workpiece 17 comprises only a single workpiece layer, the single workpiece layer comprises the first surface 34 and the second surface 36 of the workpiece. In other embodiments, the workpiece 17 may comprise three, four or more workpiece layers. Where the workpiece 17 comprises more than two workpiece layers, the second workpiece layer 20 may still be the bottom workpiece layer. The layer(s) disposed between the first workpiece layer 18 and the second workpiece layer 20 may be referred to as intermediate layer(s).

The first workpiece layer 18 and the second workpiece layer 20 may be made from any suitable material. The first workpiece layer 18 and the second workpiece layer 20 may be made from a metallic material. In the present embodiment, the first workpiece layer 18 and the second workpiece layer 20 are made from aluminium. The first workpiece layer 18 is made from cast aluminium. The second workpiece layer 20 is made from sheet aluminium. In some embodiments, the first workpiece layer 18 may be made from sheet aluminium. In some embodiments, the second workpiece layer 20 may be made from cast aluminium. Where one or both of the first workpiece layer 18 and the second workpiece layer 20 is made of cast aluminium, the diameter of the shank section 12 may be greater than for other materials. This is because the fastener 2 is typically inserted into a flange portion of a workpiece, and flanges of cast workpieces are typically larger than for, for example, sheet workpieces. Therefore, cast workpieces provide more workpiece material into which the fastener 2 can be inserted. The material of the first and/or second workpiece layers 18, 20 may have a tensile strength of at least 300 MPa. The material of the first and/or second workpiece layers 18, 20 may have a tensile strength of equal to or less than 550 MPa. In some embodiments, the material of the first and/or second workpiece layers 18, 20 may have a tensile strength of at least 100 MPa. In some embodiments, the material of the first and/or second workpiece layers 18, 20 may have a tensile strength of equal to or less than 1000 MPa. The material of the first and/or second workpiece layers 18, 20 may have a ductility, measured as percent elongation, of equal to or less than 10%. The material of the first and/or second workpiece layers 18, 20 may have a ductility, measured as percent elongation, of equal to or less than 5%.

The insertion apparatus 16 comprises a shaft 22. The shaft 22 is driven by a first actuator 24 and a second actuator 25. The first actuator 24 is an electric motor. In some embodiments, the first actuator 24 may be a pneumatic cylinder. In some embodiments, the first actuator 24 may be an air-oil actuator, or an electric-oil actuator. The first actuator 24 is configured to rotate the shaft 22 about a longitudinal axis of the shaft (not depicted in FIG. 2). The second actuator 25 is a pneumatic cylinder. In some embodiments, the second actuator 25 may be an electric motor. In some embodiments, the second actuator 25 may be an air-oil actuator, or an electric-oil actuator. The second actuator 25 is configured to move the shaft 22 in an axial direction, which is a direction that is parallel to the longitudinal axis of the shaft. The shaft 22 is capable of engaging the drive geometry 6 of the fastener 2 such that rotation of the shaft 22 also results in rotation of the fastener 2. The insertion apparatus 16 comprises a nosepiece 26. The fastener 2 is received in the nosepiece 26 prior to insertion of the fastener.

In some embodiments, the workpiece 17 is not supported on the second workpiece surface by the fastener insertion apparatus 16 while the fastener is being inserted into a workpiece. This may be referred to as a one-sided insertion. FIG. 2 shows the fastener insertion apparatus 16 carrying out a one-sided insertion. The method of inserting the fastener 2, or any other fastener disclosed herein, into a workpiece may be a one-sided insertion method.

The fastener insertion apparatus 16 may comprise a C-frame (not present in FIG. 2). C-frames may also be referred to as C-clamps. A C-frame may be provided where the workpiece 17 is to be supported on the first workpiece surface and the second workpiece surface while the fastener is being inserted into a workpiece. This may be referred to as two-sided insertion. Therefore, the method of inserting the fastener 2, or any other fastener disclosed herein, into a workpiece may be a two-sided insertion method. Two-sided insertion allows the force with which the fastener 2 is inserted into the workpiece 117 to be reacted. This results in reduced workpiece deflection as compared to one-sided insertion. Reduced workpiece deflection is advantageous because it reduces the likelihood of damage to the workpiece and/or joint defects, such as gapping, occurring.

FIG. 2 depicts the insertion apparatus 16 immediately before insertion of the fastener 2 into the workpiece 17. The insertion apparatus 16 may be any suitable commercially available insertion apparatus. For example, the insertion apparatus 16 may be an Atlas Copco KFLOW® system available from Atlas Copco IAS GmbH of Geretsried, Germany.

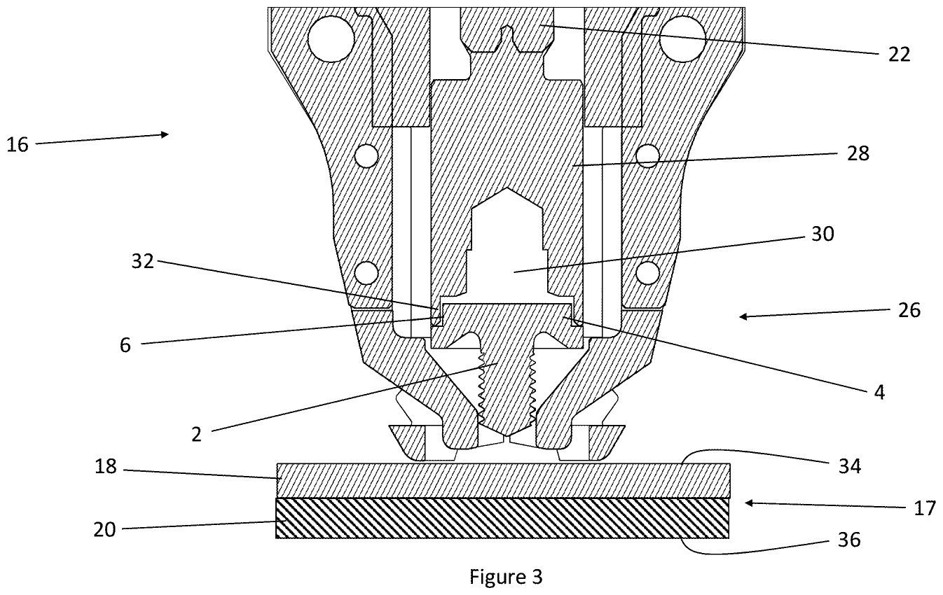

FIG. 3 shows the nosepiece 26 of the fastener insertion apparatus 16 prior to insertion of the fastener 2. The shaft 22 comprises an end portion 28. The end portion 28 of the shaft 22 comprises a bore 30. The bore 30 extends into the end portion 28. The bore 30 provides the end portion 28 of the shaft 22 with a fastener engaging portion 32. The geometry of the fastener engaging portion 32 is complementary to the drive geometry 6 of the fastener 2. The fastener engaging portion 32 is configured to engage the drive geometry 6 of the head 4 of the fastener 2. In FIG. 3, the head 4 of the fastener 2 is received within the bore 30 of the end portion 28 of the shaft 22. Therefore, rotation of the shaft 22 also results in rotation of the fastener 2. Similarly, movement of the shaft 22 in the axial direction results in movement of the fastener 2 along its longitudinal axis (not depicted in FIG. 3). When a fastener 2 is received by the fastener engaging portion 32, the longitudinal axis of the fastener 2 is coaxial with the longitudinal axis of the shaft 22.

The method of inserting the fastener 2 into the workpiece 17 will now be described. Although the method will be described with respect to the fastener 2, the method applies to all embodiments of fasteners described herein. Starting in the position shown in FIG. 3, the nosepiece 26 is brought into engagement with the first surface 34 of the workpiece 17. The shaft 22, and therefore the fastener 2, is then rotated about its longitudinal axis (not depicted in FIG. 3) such that the fastener is rotated about its longitudinal axis. The shaft 22 rotates at a speed of e.g. 3000 rpm. In some embodiments, the shaft 22 may rotate at a speed of at least 500 rpm and/or equal to or less than 12000 rpm. In some embodiments, the shaft 22 may rotate at a speed of at least 1000 rpm and/or equal to 6000 rpm. In some embodiments, the shaft may rotate at a speed of equal to or less than 9000 rpm. In some embodiments, the shaft 22 may rotate at a speed of 6000 rpm. In some embodiments, the shaft 22 may rotate at a speed of 9000 rpm. The speed at which the shaft 22 rotates may be determined by, for example, the hardness of the material from which the workpiece 17 is made. The required speed at which the shaft 22 rotates is generally increases with increasing hardness of the material from which the workpiece 17 is made. Although FIG. 3 shows the fastener 2 spaced apart from the workpiece when rotation of the shaft 22 commences, in some embodiments, the fastener 2 may be brought into contact with the workpiece 17 prior to commencement of rotation of the shaft 22 commencing. While the shaft 22 is rotating, the shaft 22 is moved along the axial direction until the tip 19 of the fastener 2 comes into contact with the first surface 34 of the workpiece 17. Once the tip 19 contacts the first surface 34 of the workpiece 17, movement of the shaft 22, and therefore of the fastener 2, in the axial direction is paused. While the movement of the shaft 22 is paused, the shaft may exert a load on the fastener 2. The load exerted by the shaft 22 on the fastener 2 may extend in the axial direction. Therefore, the load exerted by the shaft 22 on the fastener 2 may be referred to as an axial load. The load exerted by the shaft 22 on the fastener 2 may be 250 N. Rotation of the shaft 22, and therefore the fastener 2, continues, whilst the fastener 2 is in contact with the first surface 34 of the workpiece 17. This heats the workpiece 17. This is because of the friction between the tip section 14 of the fastener 2 and the first surface 34 of the workpiece 17. Where the shaft 22 exerts an axial load on the fastener 2, the magnitude of the friction generated between the tip section 14 of the fastener 2 and the first surface 34 of the workpiece 17 is greater than where the fastener is not axially loaded.

Rotation of the shaft 22, and therefore the fastener 2, continues until a pre-determined amount of heat is supplied to the workpiece 17. Heating of the workpiece 17 softens (reduces the hardness of) the material of the workpiece 17. The material of the workpiece 17 does not, however, melt. Throughout the fastener insertion process, the workpiece 17 remains below the recrystallisation temperature of the workpiece material. The recrystallisation temperature of a material is typically 40-50% of the melting temperature of the material. The recrystallisation temperature may vary depending on, for example, whether the material has undergone any cold deformation (i.e., deformation of the material without raising the temperature of the material). Aluminium alloys typically have a recrystallisation temperature of 340° C. to 400° C., and magnesium alloys typically have a recrystallisation temperature of 300° C. to 400° C. Since the material of the workpiece 17 remains below the recrystallisation temperature, the fastener insertion process is a warm forming process. Since the material of the workpiece 17 remains below the recrystallisation temperature during the fastener insertion process, the material of the workpiece 17 is less soft than if the material of the workpiece were above the recrystallisation temperature. This advantageously allows the fastener 2 to form threads in the workpiece 17 during the fastener insertion process. Throughout the fastener insertion process, the material of the first workpiece layer 18 and of the second workpiece layer 20 do not mix with one another. However, a small degree of mixing of the material of the first workpiece layer 18 with the material of the second workpiece layer 20 may occur.

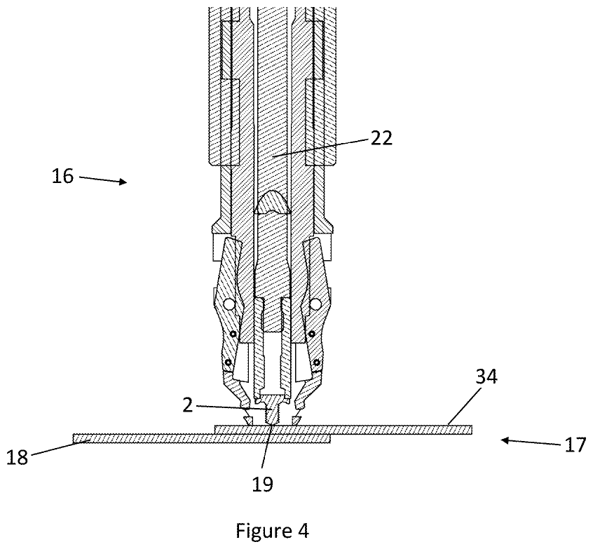

Once the predetermined amount of heat has been supplied to the workpiece 17, the shaft, and therefore the fastener 2, is moved in the axial direction such that the fastener 2 enters the workpiece 17. The load that is applied to the fastener 2 while the fastener enters the workpiece 17 is at least 500 N. In some embodiments, the load that is applied to the fastener 2 while the fastener enters the workpiece 17 is less than or equal to 20 kN. In some embodiments, the load that is applied to the fastener 2 while the fastener enters the workpiece 17 is at least 2 kN. In some embodiments, the load that is applied to the fastener 2 while the fastener enters the workpiece 17 is less than or equal to 15 kN. In some embodiments, the load that is applied to the fastener 2 while the fastener enters the workpiece 17 is less than or equal to 10 kN. In some embodiments, the load that is applied to the fastener 2 while the fastener enters the workpiece 17 is less than or equal to 5 kN. In some embodiments, the load that is applied to the fastener 2 while the fastener enters the workpiece 17 is at least 1 kN. In some embodiments, the load that is applied to the fastener 2 while the fastener enters the workpiece 17 is at least 3 kN. A higher load may be required with an increasing number of workpiece layers. In addition, the load used may be proportional to the hardness of the material from which the workpiece 17 is made. Other factors may be considered when determining the load that is applied to the fastener 2 during this stage of the fastener insertion process. This results in the fastener 2 being threaded into the workpiece 17. FIG. 4 shows the insertion apparatus 16 and fastener 2 whilst the tip 19 of the fastener 2 is in contact with the first surface 34 of the workpiece 17. The rate at which the shaft 22, and therefore the fastener 2, is moved in the axial direction is at least 0.5 mm/sec. Since the shaft 22 moves at a rate of at least 0.5 mm/sec the likelihood of the workpiece overheating during the fastener insertion process is reduced. This is because moving the fastener 2 at this rate ensures that the fastener insertion process is complete before the workpiece 17 overheats. The workpiece 17 may be considered to have overheated where the temperature of the workpiece exceeds the recrystallisation temperature of the material from which the workpiece is made. In some embodiments, the shaft 22 may move in the axial direction at a rate of at least 1 mm/sec. In some embodiments, the shaft 22 may move in the axial direction at a rate of at least 2 mm/sec. The rate at which the shaft 22 moves in the axial direction may be determined at least in part by the ductility of the material from which the workpiece 17 is made. The rate at which the shaft 22 moves in the axial direction may be higher for a higher ductility workpiece material. The rate at which the shaft 22 moves in the axial direction may be lower with decreasing ductility of the material from which the workpiece 17 is made. The rate at which the shaft 22 moves in the axial direction may also be determined at least in part by the amount of heat the is supplied to the workpiece 17 be the fastener 2. The more heat that is supplied to the workpiece 17 by the fastener, the quicker the rate at which the shaft 22 moves in the axial direction.

In some embodiments, the rate at which the shaft 22 is moved in the axial direction may be reduced at least once whilst the fastener 2 is being threaded into the workpiece 17. The reduction in speed may be such that the speed of the shaft 22 in the axial direction is non-zero following the reduction. The reduction in the rate at which the shaft 22 is moved in the axial direction may be such that after the reduction the speed of the shaft 22 in the axial direction is at least 50% of the speed of the shaft in this direction prior to the reduction. The reduction in the rate at which the shaft 22 is moved in the axial direction may be such that, following the reduction, the shaft moves in the axial direction by a distance that is equal to or less than the pitch distance of the thread of the shank section 12 of the fastener 2 per revolution of the shaft. Advantageously, this reduces the likelihood of the threads formed in the workpiece 17 by the fastener 2 being stripped. The threads being stripped is undesirable because this can cause, for example, poor joint strength. The term ‘pitch distance’ may be understood to refer to the distance between corresponding points of the thread of the shank section. Where the rate at which the shaft 22 moves in the axial direction is such that the shaft moves in the axial direction by a distance that is less than the pitch distance of the thread of the shank 12 of the fastener 2 per revolution of the shaft, the material of the workpiece 17 is preferably sufficiently soft such that the thread is reformed in the workpiece with each revolution of the shaft 22, and therefore fastener 2. The reduction of the speed of the shaft 22 in the axial direction may occur when the tip 19 of the fastener 2 is disposed in the second workpiece layer 20. The reduction in the speed of the shaft 22 in the axial direction may occur when the tip 19 comes into contact with the second workpiece layer 20. The position of the tip 19 may be determined by, for example, monitoring the position of the shaft 22 and determining the amount by which the shaft has moved in the axial direction.

As the fastener 2 is moved in the axial direction, the material of the workpiece 17 deforms around the tip section 14 and around the shaft section 12 of the fastener 2. The material of the workpiece 17 deforms into the threads of the shank section 12. Therefore, a thread is formed in the material of the workpiece 17 such that the fastener 2 is threaded into the workpiece 17. In addition, an aperture (or hole), in which the fastener 2 is received, is formed in the workpiece 17. Movement of the shaft 22, and therefore of the fastener 2, in the axial direction continues until the tip section 14 is disposed within the second workpiece layer 20. Movement of the shaft 22, and therefore of the fastener 2, in axial direction ceases prior to the tip 19 of the fastener 2 penetrating the second surface 36 of the workpiece 17. Therefore, once the fastener insertion process is complete, the tip 19 of the fastener 2 is disposed within the second workpiece layer 20 of the workpiece 17. In addition, once the fastener insertion process is complete, the underside 15 of the head of the fastener 2 contacts the first surface 34 of the workpiece 17.

In some embodiments, the speed at which the shaft 22 is rotated about its longitudinal axis, and therefore the speed at which the fastener 2 is rotated about its longitudinal axis, may be reduced at least once whilst the fastener 2 is being threaded into the workpiece 17. The reduction in rotational speed may be such that the rotational speed of the shaft 22 is non-zero following the reduction. The reduction in the rate at which the shaft 22 rotates be such that the rotational speed of the shaft 22 following the reduction is at least 50% of the rotational speed of the shaft 22 prior to the reduction. In some embodiments, the reduction in the rate at which the shaft 22 rotates be such that the rotational speed of the shaft 22 following the reduction is at least 30% and/or less than or equal to 70% of the rotational speed of the shaft 22 prior to the reduction. The reduction of the rotational speed of the shaft 22 may occur when the tip 19 of the fastener 2 is disposed in the second workpiece layer 20. The reduction in the rotational speed of the shaft may occur when the tip 19 contacts the second workpiece layer 20. The rotational speed of the shaft 22 following the reduction may be, for example, 300 rpm.

Following the reduction in the rotational speed, the amount of heat that is supplied to the workpiece 17 is reduced relative to the amount of heat that is supplied to the workpiece 17 prior to the reduction. This causes the temperature of the material of the workpiece 17 to also reduce. As the temperature of the material of the workpiece 17 reduces, the torque that is required to rotate the shaft 22 at a constant, or approximately constant, rotational speed increases. In addition, the torque that is required to rotate the shaft 22 at a constant, or approximately constant, rotational speed increases when the underside 15 of the head 4 of the fastener 2 contacts the first surface 34 of the workpiece 17. The torque that is required to rotate the shaft 22 is monitored throughout the fastener insertion process. When the torque that is required to rotate the shaft 22 reaches a predetermined value, rotation of the shaft 22, and therefore of the fastener 2, ceases. The pre-determined torque value at which rotation of the shaft 22 ceases may be at least 3 Nm. The predetermined torque value at which rotation of the shaft 22 ceases may be less than or equal to 30 Nm. The pre-determined torque value at which rotation of the shaft ceased may be at least 10 Nm. The predetermined torque value at which rotation of the shaft 22 ceases may be less than or equal to 20 Nm. The predetermined torque value at which rotation of the shaft 22 ceases may be 10 Nm. The magnitude of the predetermined torque may be determined by, for example, the required connection strength and/or the material from which the workpiece 17 is made.

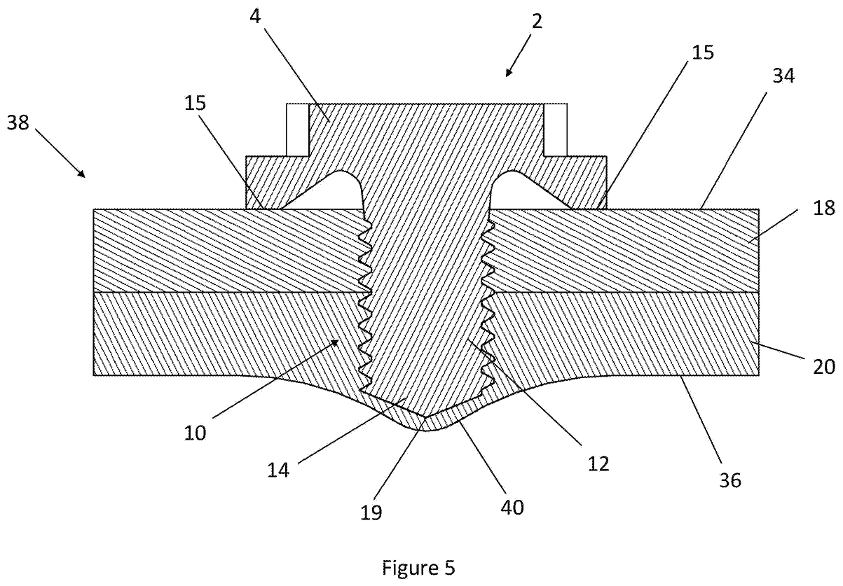

FIG. 5 shows a joint 38 resulting from the process of inserting the fastener 2 into the workpiece 17. The head 4 of the fastener 2 is proud of the workpiece 17. In other words the head 4 protrudes beyond the first surface 34 of the workpiece 17. In some embodiments, the head 4 may be flush with the workpiece. The head 4 is flush with the workpiece 17 if the head is generally coplanar with the first surface 34 of the workpiece 17. The fastener 2 is removable from the joint 38. In some embodiments, the fastener 2 may not be removable. Whether or not the fastener 2 is removable from the joint 38 is determined by the function of the fastener in use. The underside 15 of the head 4 of the fastener 2 engages the first surface 34 of the workpiece 17. The tip section 14 of the fastener 2 is disposed within the second workpiece layer 20. The tip section 14 has not penetrated the second surface 36 of the workpiece 17. Therefore, the tip section 14 of the fastener 2 has only partially penetrated the second workpiece layer 20. As a result of the fastener insertion process, the second workpiece layer 20 now comprises a protrusion 40. This is because the fastener 2 has displaced a volume of material of the workpiece 17. The protrusion 40 extends from the second surface 36 of the workpiece 17. The tip 19 of the fastener 2 is disposed within the protrusion 40. No part of the tip section 14 of the fastener 2 extends through the second surface 36 of the workpiece 17.

Since the temperature of the workpiece 17 does not exceed the recrystallization temperature of the material of the workpiece 17 throughout the fastener insertion process, the joint 38 comprises a thermo-mechanically affected zone (TMAZ). The thermos-mechanically affected zone is characterised by the material of the workpiece 17 that is subject to both heating and mechanical shearing during the fastener insertion process. The thermo-mechanically affected zone is disposed adjacent an interface between the workpiece 17 and the fastener 2.

The quality of the joint produced using the insertion process is a function of the amount of heat that is supplied to the workpiece 17 during the fastener insertion process. Under heating or overheating of the workpiece during the fastener insertion process can result in joint defects. Examples of such joint defects are inadequate engagement between the threads of the shank section 12 of the fastener 2 and the workpiece 17, or separation of the first workpiece layer 18 from the second workpiece 20. Separation between the first workpiece layer 18 and the second workpiece layer 20 may be referred to as gapping. Gapping is undesirable because environmental substances, such as water, can enter the joint, and can damage the joint. The amount of heat supplied to the workpiece 17 during the fastener insertion process is a function of the tip angle α of the tip section 14 of the fastener 2. The tip angle α of the fastener 2 of the present embodiment can be optimised within the range of at least 50° such that an optimised amount of heat to the workpiece 17. The optimum tip angle α is a function of at least the ductility of the material of the workpiece 17, the hardness of the material of the workpiece 17, the rate at which the fastener is inserted during the fastener insertion process, and the rate at which the fastener is moved axially during the fastener insertion process. This reduces the likelihood of under heating or over heating of the workpiece 17 occurring during the fastener insertion process relative to where the tip angle α of a fastener falls outside of the range of the tip angle α of the present embodiment.

In some embodiments the fastener insertion process may include applying an adhesive to the first and/or second workpiece layers 18, 20. The adhesive is applied to the first and/or second workpiece layers 18, 20 prior to the workpiece 17 being provided to the fastener insertion apparatus 16. The adhesive may be applied as a liquid paste layer or as a film layer. The adhesive is applied in the regions of the first workpiece layer 18 and the second workpiece layer 20 through which the fastener 2 is to be inserted. The first workpiece layer 18 and the second workpiece layer 20 are then brought into engagement with one another. Once the first workpiece 18 and the second workpiece 20 have been brought into engagement with one another the adhesive is disposed between the first workpiece layer 18 and the second workpiece 20. The fastener insertion process then continues as discussed above, with the fastener passing through the adhesive layer. Where an adhesive is applied, the joint resulting from the fastener insertion process comprises an adhesive layer that is disposed between the first workpiece layer and the second workpiece layer.

The fastener insertion apparatus 16 does not require a die. Where the fastener insertion apparatus 16 does not include a die, the method of inserting the fastener 2 into a workpiece 17 may be a one-sided insertion or a two-sided insertion. The absence of a die may be particularly useful where, for example, the workpiece 17 is a box section or where the point of the workpiece at which the fastener 2 is to be inserted is not accessible from both sides by the fastener insertion apparatus. In these cases, a one-sided insertion may be appropriate. However, a two-sided insertion method may also be used. The absence of a die may also be beneficial for thicker workpieces (e.g., workpieces having a total thickness of at least 6 mm). This is because thicker workpieces are able to better accommodate the volume occupied by the fastener.

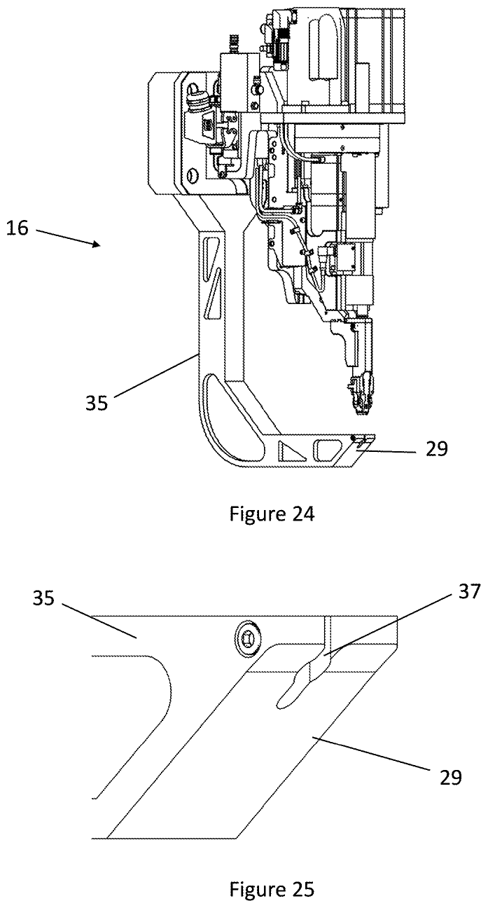

FIG. 24 shows a fastener insertion apparatus 16 that does not include a die. With this fastener insertion apparatus 16, the second surface of the workpiece (not shown) is supported on a lower arm 29 of the C-frame 35. Therefore, the fastener insertion apparatus 16 of FIG. 24 allows two-sided insertion of a fastener. FIG. 25 shows a detail view of the lower arm 29 of the C-frame 35. The lower arm 29 of the C-frame 35 comprises a die holder 37. A stem of a die (not shown) is receivable in the die holder 37. A two-sided insertion of a fastener may be carried out with or without a die received in the die holder 37.

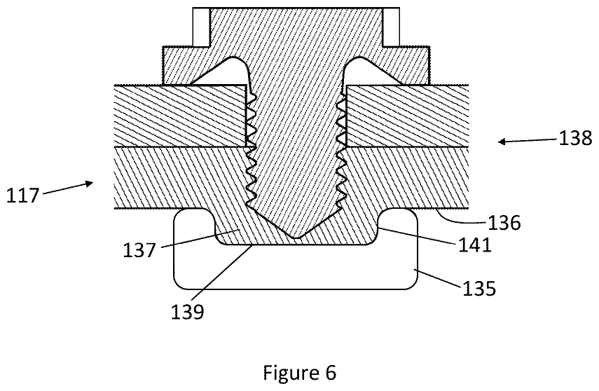

In some embodiments, a die may be provided during the fastener insertion process. FIG. 6 shows a further embodiment of a joint 138 with a die 135. The die 135 forms a part of a fastener insertion apparatus (not depicted), and may for example be provided on an opposite side of a C-clamp (or other clamp) from a punch of the fastener insertion apparatus. The die is receivable in the die holder of the lower arm of the C-clamp.

The die 135 defines a die recess 137. The die recess 137 defines a die recess volume. The die recess 137 comprises a base surface 139. The die recess 137 comprises a sidewall 141. In the depicted embodiment, the die recess 137 is generally cylindrical. In other embodiments, the die recess 137 may be any suitable shape. For example, the die recess may be frustoconical.

During the fastener insertion process, the die 135 engages the second surface 136 of the workpiece 117. The die 135 engages the second surface of the workpiece 117 throughout the fastener insertion process. The die 135 is brought into contact with the second surface 136 of the workpiece 117 prior to the fastener 2 making contact with the workpiece 117. As discussed above, as the fastener 2 is inserted into the workpiece 117, at least some of the material of the workpiece 117 is displaced. Where the die 135 is provided, the material of the workpiece 117 that is displaced deforms into the die recess 137. The volume of the die recess 137 may be equal to or greater than the volume of workpiece material that is displaced during the fastener insertion process.

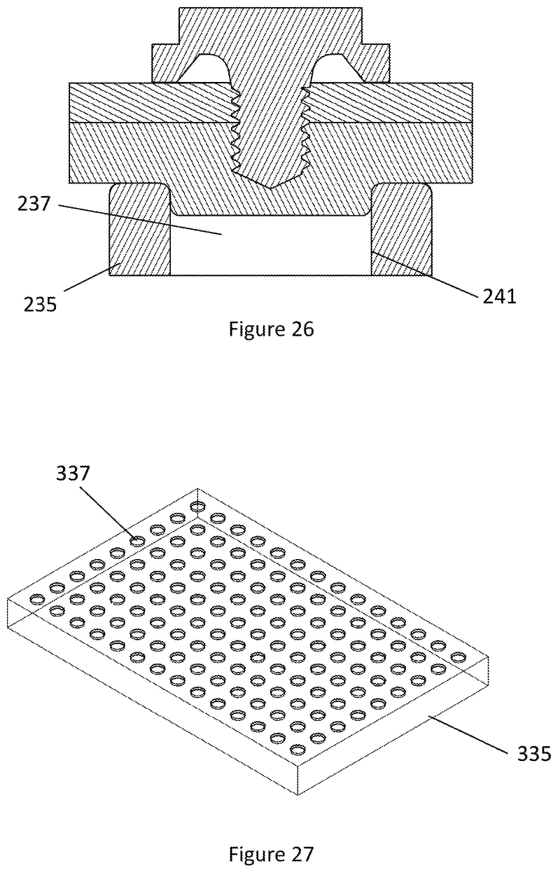

FIG. 26 shows an alternative die 235. The die 235 is similar to the die 135. The die 235 differs from the die 135 in that the die recess 237 does not comprise a base surface. The die recess 237 comprises a sidewall 241. Since the die recess 237 does not comprise a base surface, deformation of the workpiece material in the direction that the fastener is inserted into the workpiece is less restricted as compared to a die recess that does comprise a base surface. Deformation of the workpiece material is moulded by the sidewall 241 of the die recess 237. The die may comprise a surface that is disposed at or towards a bottom end of the recess, the surface being spaced apart from the second surface of the workpiece, in use. With this arrangement, the second surface does not come into contact with the base surface during a fastener insertion process.

FIG. 27 shows a further alternative die 335. The die 335 may be used with the fastener insertion apparatus 2 shown in FIGS. 2 to 4. The die 335 is in the form of a die table. The die table 335 comprises a plurality of die recesses 337. When inserting a fastener into a workpiece using the die 335, the nosepiece of the fastener insertion apparatus (not shown) is positioned above one of the die recesses 337. The die 337 allows a plurality of fasteners to be inserted at different locations of a workpiece (not shown) without moving the workpiece. In some embodiments, the die recesses 337 of the die table may take the form of a continuous channel or a continuous groove that extends along a length or width of the die table.

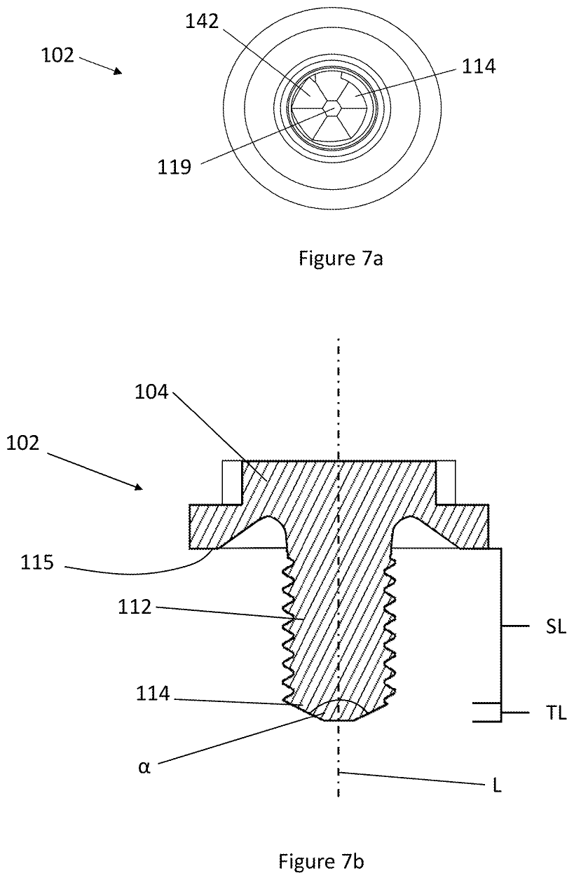

In some embodiments, the fastener may comprise a plurality of surface irregularities. FIGS. 7a and 7b show such an embodiment of a fastener 102. Like numerals for the fastener 2 have been used for the fastener 102. In this embodiment, the tip section 114 is depicted as being frustoconical. However, in other embodiments, the tip section may be conical. Since the tip section 114 is frustoconical, the tip 119 of the tip section defines a planar surface section.

The fastener 102 differs from the fastener 2 of FIG. 1 in that the tip section 114 of the fastener 102 comprises a plurality of surface irregularities 142 (only one of which is labelled in FIG. 6). In the depicted embodiment, the surface irregularities are in the form of facets 142. In the depicted embodiment, the plurality of facets 142 comprises six facets. However, in other embodiments, the plurality of facets 142 can comprise any suitable number of facets. In some embodiments, the plurality of facets 142 may comprise at least two facets. In some embodiments, the plurality of facets 142 may comprise at least four facets. In some embodiments, the plurality of facets 142 may comprise less than or equal to nine facets. In some embodiments, the plurality of facets 142 may comprise less than or equal to eight facets. The optimum number of facets of the plurality of facets 142 may be determined by, for example, the desired fastener insertion time (i.e., the time required to insert the fastener into a workpiece), the material properties of the workpiece into which the fastener 102 is to be inserted. With an increasing number of facets, the amount of heat supplied to the workpiece during the fastener insertion process also increases. Where the workpiece is made from aluminium, the optimum number of facets is preferably six. This is because the likelihood of the workpiece being overheated or under heated is minimised. The plurality of facets 142 are arranged as an array. Therefore, the plurality of facets 142 are distributed around the longitudinal axis of the fastener 2. In the depicted embodiment, the plurality of facets 142 adjoin one another. However, in other embodiments, the facets of the plurality of facets 142 may be spaced apart from one another. Where the facets of the plurality of facets 142 are spaced apart from one another, radiused surface sections may be disposed between the facets. Each facet of the plurality of facets 142 is in the form of a planar surface section. However, in other embodiments, each facet of the plurality of facets 142 may be in the form of a radiused surface section.

FIG. 7b shows a cross-sectional side view of the fastener 102. The tip section 114 defines a tip section length TL. The tip section length TL extends along a direction that is parallel to a longitudinal axis L of the fastener 102. The shank section 112 defines a shank section length SL. The shank section length SL extends along a direction that is parallel to the longitudinal axis L of the fastener 102. The shank section length SL extends from the underside 115 of the head 104 of the fastener 102 to the tip section 114. A ratio of the shank section length SL to the tip section length TL is at least 2.5. In some embodiments, the ratio of the shank section length SL to the tip section length TL may be at least 3. In some embodiments the ratio of the shank section length SL to the tip section length TL may be at least 3.5. In some embodiments, the ratio of the shank section length SL to the tip section length TL may be at least 2. The ratio of the shank section length SL to the tip section length TL may be determined by, for example, the required connection strength provided by the fastener 102, and/or the total thickness of the workpiece into which the fastener 102 is to be inserted. A larger ratio of shank section length SL to tip section length TL increases the connection strength because more thread is provided to be secured to the workpiece 17. The ratios of the shank section length to the tip section length disclosed herein may apply to all embodiments of fastener disclosed in this document.

Referring again to FIG. 7a, each facet of the plurality of facets 142 extends from the tip 119 towards the shank section 112. In particular, each facet of the plurality of facets 142 extends from the tip 119 to the shank section 112. However, in some embodiments, each facet of the plurality of facets 142 may not extend all the way to the shank section 112, but may, instead, extend from the tip 119 towards the shank section 112. In which case, a surface section is disposed between the plurality of facets 142 and the shank section 112. Whether the plurality of facets 142 extend all the way to the shank section 112 or not may be determined by the material from which the workpiece is made. The plurality of facets 142 extending to the shank section 112 provides the workpiece with more heat compared to where the plurality of facets 142 do not extend all the way to the shank section 112. The tip angle α of the fastener 102 varies around the longitudinal axis L of the fastener. The tip angle α of the fastener 102 is determined by the smallest angle between two diametrically opposed points of the tip section 112.

As discussed above, the method of inserting the fastener 2, as described above, applies to each of the fasteners disclosed in this document. In use, the plurality of facets advantageously reduce the likelihood of the workpiece being under heated while inserting the fastener 102 into a workpiece. The facets of the plurality of facets 142 increase the amount of friction between the tip section 114 and the workpiece (compared with a rotationally symmetric tip section). This increase in friction increases the amount of heat that is generated between the tip section and the workpiece, thereby reducing the likelihood of the workpiece being under heated whilst the fastener 102 is being inserted. Since the likelihood of under heating of a workpiece occurring while inserting the fastener 102 is reduced, the quality of the joint created using the fastener 102 is improved (compared with a joint created using a fastener which does not have a plurality of facets).

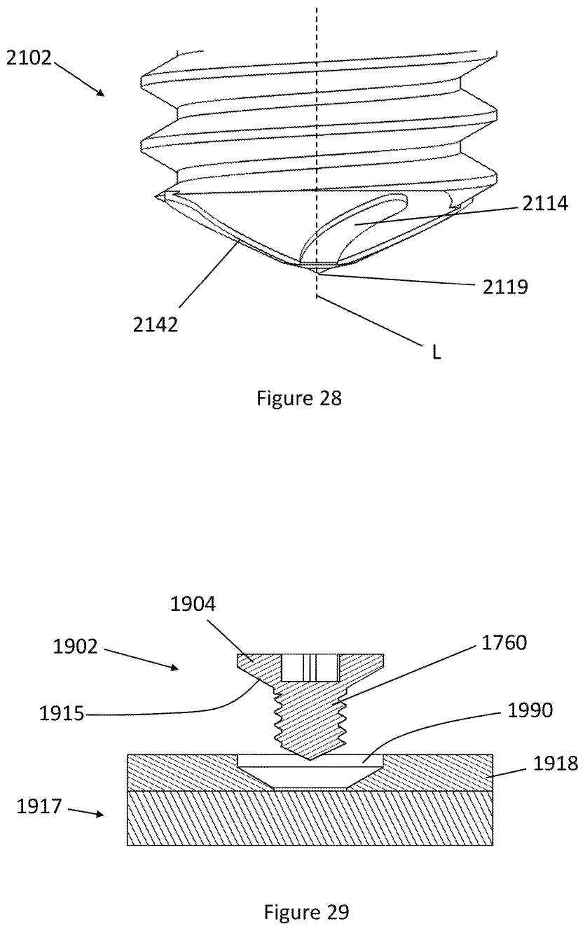

In some embodiments, the plurality of surface irregularities may be in the form of a plurality of ribs. Such an embodiment is shown in FIG. 28. The plurality of ribs 2142 provide the same benefits as the plurality of facets 142. The plurality of ribs 2142 comprises four ribs. However, in some embodiments, the plurality of ribs 2142 may comprise at least two ribs and/or up to six ribs. A component of the length of each rib of the plurality of ribs 2142 extends in a radial direction (i.e., perpendicular to a longitudinal axis L of the fastener 2102). The ribs 2142 extend from the tip 2119 of the tip section 2114. A component of the length of each rib of the plurality of ribs 2142 extends in a circumferential direction (i.e., about the longitudinal axis L of the fastener 2102). A thickness and/or width of the ribs 2142 may be either uniform of non-uniform. The thickness of the ribs 2142 may be understood to refer to the distance by which they protrude from a surface of the tip section 2114. The thickness and/or width of the ribs 2142 may be at a minimum at or adjacent to the tip 2119 of the tip section 2114. The thickness and/or width of the ribs 2142 may be at a maximum at or adjacent to the tip 2119 of the tip section 2114. In some embodiments, the plurality of surface irregularities may include two or more facets and one or more ribs.

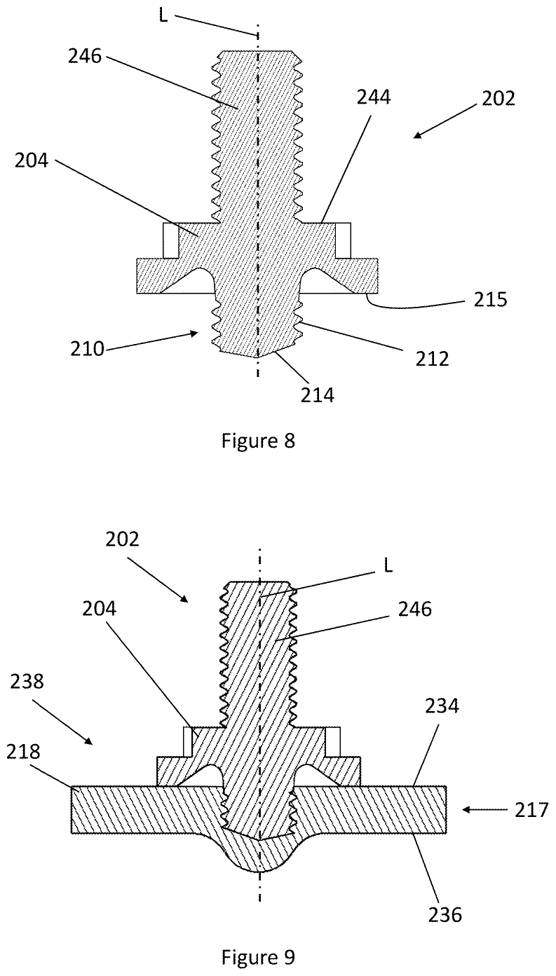

In some embodiments, the fastener may comprise a fixing point. In some embodiments, the fixing point is in the form of a stud. Preferably, where the fastener comprises a stud, the fastener insertion apparatus does not comprise a die. This is because, where the fastener comprises a stud, the point of the workpiece into which the fastener is to be inserted is often inaccessible for a die. However, the fastener insertion apparatus may include a die where the fastener comprises a stud. FIG. 8 shows an embodiment of a fastener 202 which comprises a fixing point. Like numerals for the fasteners 2, 102 have been used for the fastener 202. The fastener 202 differs from the fasteners 2, 102 in that the fastener 202 further comprises a stud 246. However, the tip angle of the fastener 202 may correspond with the tip angle of the fastener 2. Similarly, the tip section 214 may comprise a plurality of facets.

The stud 246 extends from a top side 244 of the head 204 of the fastener 202. The topside 244 is opposed to the underside 215 of the head 204. The stud 246 is threaded. The stud 246 is generally cylindrical. The stud 246 extends along the longitudinal axis L of the fastener 202. The stud 246 allows a component, such as an electrical contact, to be secured to the fastener 202. The stud 246 defines a diameter. The diameter of the stud 246 need not be the same as the diameter of the shank section 212. The diameter of the stud 246 may be at least 2 mm. The diameter of the stud 246 may be less than or equal to 10 mm. The diameter of the stud 246 may be at least 3 mm. The diameter of the stud 246 may be less than or equal to 8 mm. The diameter of the stud 246 may be less than or equal to 10 mm. The diameter of the stud 246 may be at least 3 mm. The diameter of the stud 246 may be less than or equal to 8 mm. The diameter of the stud 246 need not be an integer. For example, the diameter of the stud 246 may be 4.5 mm.

In some embodiments, the fixing point may be in the form of, for example, a loop that extends from the topside 244 of the fastener 202.

FIG. 9 shows the fastener 202 inserted into a workpiece 217, thereby forming a joint 238. In the depicted embodiment, the workpiece 217 comprises the first workpiece layer 218. The first workpiece layer 218 is the only workpiece layer of the workpiece 217. However, in other embodiments, the workpiece 217 may comprise a plurality of workpiece layers. Since the first workpiece layer 218 is the only workpiece layer, the first workpiece layer 218 comprises the first surface 234 of the workpiece and the second surface 236 of the workpiece.

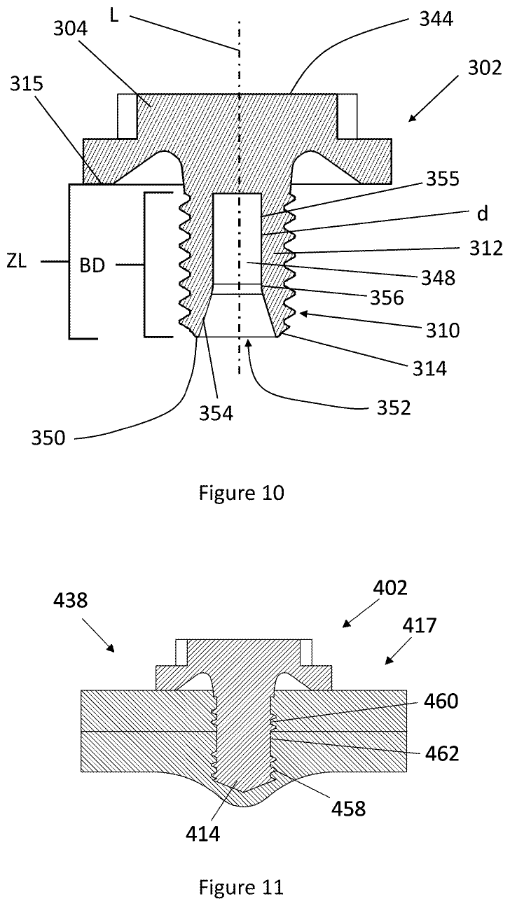

In some embodiments, the fastener may comprise a bore. FIG. 10 shows such an embodiment of a fastener 302. Like numerals for the fasteners 2, 102, 202 have been used for the fastener 302. Although not depicted, the fastener 302 may also comprise a stud that extends from the top side 344 of the head 304 of the fastener 302.

The fastener 302 comprises a bore 348. The bore 348 extends into the tip section 314 of the fastener 302. The bore 348 extends along a direction that is parallel with the longitudinal axis L of the fastener 302. The shank 310 defines a shank length ZL. The bore 348 defines a bore depth BD. A ratio of the bore depth BD to the shank length ZL may be at least 0.25. In other words, the bore 348 extends along at least 25% of the shank length ZL. The tip section 314 comprises a ring leading edge 350. The shank length ZL extends from the underside 315 of the head 304 to the ring leading edge 350. The ring leading edge 350 may define a ring surface. In the depicted embodiment, the ring leading edge 350 is planar. However, in some embodiments the ring leading edge 350 may be non-planar. In such embodiments, the ring leading edge 350 may be serrated. The ring leading edge 350 being serrated reduces the likelihood of the workpiece being under heated during the fastener insertion process. The bore defines a bore surface 355. In some embodiments, the bore surface 355 may define a plurality of surface irregularities. The surface irregularities may be in the form of, for example, tabs, ribs and/or protrusions. Where the bore surface 355 defines a plurality of surface irregularities the surface irregularities interlock with the workpiece into which the fastener 302 has been inserted, thereby improving the strength of the connection between the fastener 302 and the workpiece.

The tip angle α of the tip section 314 is at least 50°. Because the fastener 302 comprises the bore 348, and so the tip section 314 defines the ring leading edge 350, the initial contact area between the fastener 302 is greater than if the bore 348 were not present, for a constant tip angle. This allows the tip angle α of the tip section 314 of the fastener 302 to be reduced relative to where no bore is present because the increase in contact area increases the amount of heat that is supplied to a workpiece in use. Thus, when a bore is present the fastener may for example work well when the tip angle is at least 50°, and when no bore is present the fastener may for example work well when the tip angle is at least 70°.

The bore 348 defines a bore internal diameter d. A ratio of the shank diameter to the bore internal diameter d may be at least 1.5. This advantageously provides sufficient material in the shank section 312 such that the fastener 302 is able to withstand force as required in use. In some embodiments, the ratio of the shank diameter to the bore internal diameter d may be at least two.

The ring leading edge 350 merges into the bore internal diameter d by virtue of a tapered surface section 352. The tapered surface section 352 comprises a chamfered surface section 354. The angle between diametrically opposed points of the chamfered surface section 354 is at least 25 degrees. The angle between diametrically opposed points of the chamfered surface section 354 is less than or equal to 45 degrees. The chamfered surface section 354 adjoins the ring leading edge 350. The tapered surface section 352 comprises a radius surface section 356. The radius surface section 356 adjoins the chamfered surface section 354. The radius surface section 356 adjoins the bore internal diameter d. In some embodiments, the tapered surface section 352 may comprise only one of the chamfered surface section 354 and the radius surface section 356. In some embodiments, the chamfered surface section 354 may adjoin the bore internal diameter d and the radius surface section 356 may adjoin the ring leading edge 350. In some embodiments, the entirety of the bore 348 may be cylindrical.

During the fastener insertion process a volume of workpiece material is displaced by the fastener 304. The presence of the bore 348 advantageously reduces the amount of workpiece material that is displaced during the fastener insertion process. This is because a volume of workpiece material is received by the bore, thereby reducing the amount of workpiece material that is displaced by the fastener 302. Since the bore 348 extends along at least 25% of the shank length, the amount of material displaced by the fastener 302 during the fastener insertion process is sufficient such that the likelihood of the workpiece layer separating is reduced. The tapered surface section 352 advantageously encourages deformation of the material of the workpiece into the bore 348. The geometry by which the ring leading edge 350 merges into the bore internal diameter advantageously distributes the stress that the fastener 302, in particular the shank 310, is subject to during the fastener insertion process more evenly.

The bore 348 defines a bore depth. The bore depth extends from the ring leading edge 350 and towards the head 304 in a direction that is parallel to the longitudinal axis L of the fastener 302. The tapered surface section 352 defines a tapered surface section depth. The tapered surface section depth extends from the ring leading edge 350 towards the head 304 of the fastener 302 in a direction that is parallel to the longitudinal axis L of the fastener 302. A ratio of the tapered surface section depth to the bore depth is at least 0.1. In some embodiments, the ratio of the tapered surface section depth to the bore depth is preferably at least 0.2. The ratio of the tapered surface section depth to the bore depth being at least 0.2 provides gradual transition between the ring leading edge 350 and the bore internal diameter d. This provides more even stress distribution in the tip section 314 during the fastener insertion process, thereby reducing the likelihood of a defect occurring while inserting the fastener 302 into a workpiece. In some embodiments, the ratio of the tapered surface section depth to the bore depth may be at least 0.5.

In some embodiments, the fastener may not be removable from the workpiece into which it has been inserted. FIG. 11 shows such an embodiment of a fastener 402. Like numerals for the fasteners 2, 102, 202, 302 have been used for the fastener 402. The fastener 402 may comprise a bore, a stud, a plurality of facets, and/or a tip angle in accordance with the previous embodiments described herein.

The shank section 412 comprises a first thread portion 458. The first thread portion 458 adjoins the tip section 414. The shank section 412 comprises a second thread portion 460. The shank section 412 comprises a plain portion 462. The plain portion 462 may be referred to as a horizontal thread gap. The plain portion 462 is disposed between the first thread portion 458 and the second thread portion 460. FIG. 11 shows the fastener 402 inserted into a workpiece 417, thereby forming a joint 438. The plain portion 462 spaces the first thread portion 458 and the second thread portion 460 apart from one another. Because of this, it is not possible to remove the fastener 402 from the workpiece 417 by rotating the fastener 402 in an opposite direction to the threads of the shank section 412. This is because the material of the workpiece 417 interferes with the second thread portion 460, thereby preventing rotation of the fastener. During the fastener insertion process, the material of the workpiece 417 is softened due to the heat supplied to it. The material of the workpiece 417 being softened allows the material of the workpiece to deform around the first thread portion 458 and the second thread portion 460. In some embodiments, the pitch distance, the thread angle, and/or the diameter of the first thread portion 458 may be greater than or equal to that of the second thread portion 460. In some embodiments, the pitch distance and/or diameter of the first thread portion 458 may be less than or equal to that of the second thread portion 460.

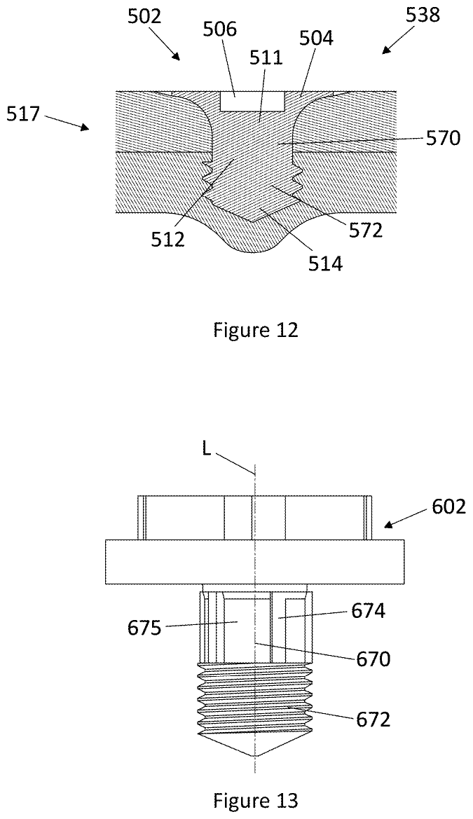

In some embodiments, at least part of the shank section of the shank of the fastener is not threaded. FIG. 12 shows an embodiment of such a fastener 502 that is inserted into a workpiece 517, thereby forming a joint 538. Like numerals for the fasteners 2, 102, 202, 302, 402 have been used for the fastener 502. In this embodiment, the drive geometry 506 of the head 504 of the fastener 502 is an internal drive geometry. However, the drive geometry 506 may be an external drive geometry, or otherwise. The fastener 502 may comprise any of the features disclosed in relation to the previous embodiments described herein.

The shank section 512 comprises a first shank portion 570. The shank section 512 comprises a second shank portion 572. The first shank portion 570 adjoins the head 504 of the fastener 502. The first shank portion 570 comprises the base section 511 of the shank section 512. The second shank portion 572 adjoins the first shank portion 570 and the tip section 514. The first shank portion 570 is not threaded. The second shank portion 572 is threaded. Since only part of the shank section 510 is threaded, the force that is required to insert the fastener 502 into a workpiece is reduced relative to where the entire shank section is threaded. This is because the resistance to insertion of the fastener is reduced relative to where the entire shank section 510 is threaded (this is because less surface area is in contact with the workpiece).

In some embodiments, the fastener may comprise one or more retaining features that, in use, engage a workpiece into which the fastener is inserted. FIG. 13 depicts an embodiment of such a fastener 602. Like numerals for the previous embodiments of the fastener described herein have been used for the fastener 602. The first shank portion 670 of the fastener 602 is not threaded. The second shank portion 672 is threaded. The first shank portion 670 comprises a plurality of protrusions 674 (only one of which is labelled in FIG. 13). The plurality of protrusions 674 are arranged as an array. Disposed alternatively between the plurality of protrusions 674 are a plurality of cavities 675. The plurality of protrusions 674 comprises six protrusions. However, in other embodiments, the plurality of protrusions may comprise any suitable number of protrusions. The plurality of protrusions 674 do not extend radially beyond the threads of the second shank portion 672. In some embodiments, the plurality of protrusions 674 may project radially beyond the threads of the second shank portion 674. In the depicted embodiment, the protrusions of the plurality of protrusions 674 extend parallel to the longitudinal axis L of the fastener 602. In other embodiments, the protrusions of the plurality of protrusions may be twisted about the longitudinal axis L of the fastener 602. Where the plurality of protrusions twist about the longitudinal axis L of the fastener 602, the protrusions of the plurality of protrusions 674 extend around the longitudinal axis L of the fastener 602 and in a direction parallel to the longitudinal axis L of the fastener.

When inserted into a workpiece (not shown in FIG. 13), the material of the workpiece deforms around the plurality of protrusions 674 and into the cavities of the plurality of cavities 675. The material of the workpiece at least partially fills the cavities of the plurality of cavities 675. Therefore, in use, the plurality of protrusions 674 engage the workpiece into which the fastener is inserted. Rotation of the fastener 602 following insertion is therefore prevented by virtue of the interaction between the plurality of protrusions 674 and the material of the workpiece. Therefore, the plurality of protrusions 674 can be referred to as retaining features. In some embodiments, only one protrusion need be provided. Therefore, the fastener 602 comprises one or more retaining features. In some embodiments, the one or more retaining features may be in the form of, for example, ribs that extend around, or in a direction parallel to, the longitudinal axis L of the fastener 602.

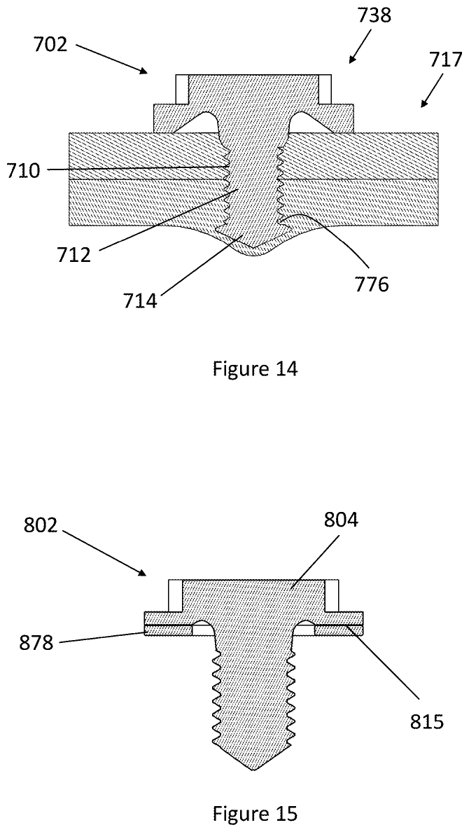

In some embodiments, the tip section of the fastener may define an undercut. Such an embodiment is shown in FIG. 14. Like numerals for the previous fasteners disclosed herein have been used for the fastener 702. FIG. 14 shows the fastener 702 inserted into a workpiece 717, thereby creating a joint 738. The maximum diameter of the tip section 714 of the shank 710 is greater than the diameter of the shank section 712 of the shank 710. Therefore, an undercut 776 is defined by the tip section 714. The undercut 776 is disposed adjacent to the shank section 712. Because of the undercut 776, the amount of interference between the fastener 702 and the workpiece 717 is increased relative to where the undercut 776 is not provided. This increase in interference between the fastener 702 and the workpiece 717 increases the connection strength between the fastener 702 and the workpiece 717.

In some embodiments, the fastener may comprise a washer. Such an embodiment is shown in FIG. 15. Like numerals for the previous embodiments disclosed herein have been used for the fastener 802. The fastener 802 may comprise any of the features described with reference to the previous embodiments. The fastener 802 comprises a washer 878. The washer 878 engages the underside 815 of the head 804 of the fastener 802. Providing the washer 878 reduces the likelihood of the fastener rotating during use (i.e. after the joint has been formed). Rotation of the fastener 802 in use is undesirable because this can result in loosening of the fastener. Therefore, providing the washer 878 provides a more robust joint. The washer 878 may be configured such that, in use, the washer seals against the head 804 of the fastener 802 and against the workpiece (not shown in FIG. 15). The seal may be a watertight seal such that water, or other liquids, cannot pass under the head 804 of the fastener in use. The presence of water under the head 804 of the fastener is undesirable because this can lead to corrosion. The washer 878 may be made from aluminium. The washer 878 being formed of aluminium may be particularly advantageous where the fastener 802 is formed of steel and the workpiece is formed of magnesium. The washer 878 being formed of aluminium prevents the formation of a galvanic corrosion cell.

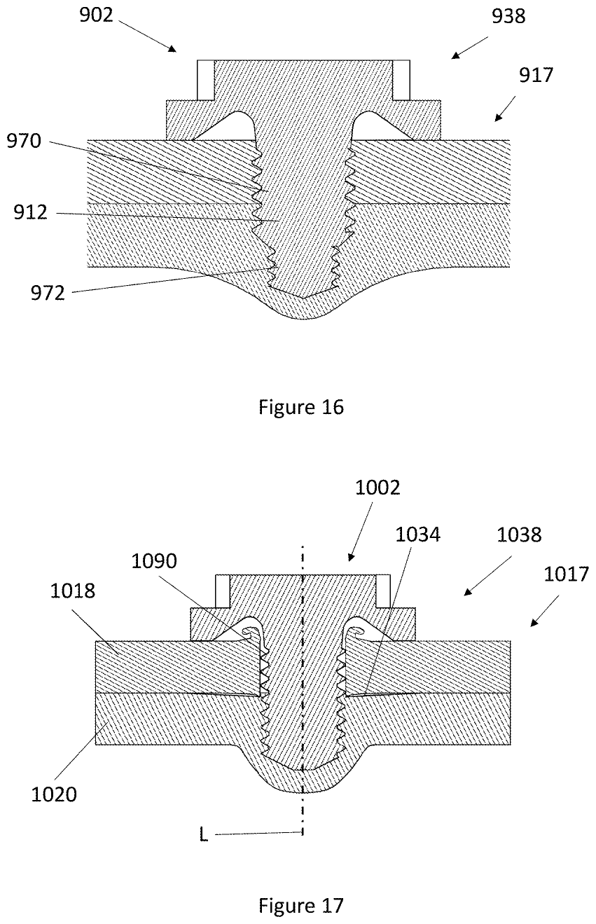

In some embodiments, the diameter of the shank of the fastener need not be uniform along the length of the shank. Such a fastener 902 is shown in FIG. 16. Like numerals for the fasteners of the previous embodiments have been used for the fastener 902. FIG. 16 shows the fastener 902 inserted into a workpiece 917, thereby creating a joint 938. The fastener 902 may comprise any of the features described with reference to the previous embodiments. In this embodiment, the diameter of the first shank portion 970 is greater than the diameter of the second shank portion 972. In other embodiments, the diameter of the second shank portion 972 may be greater than the diameter of the first shank portion 970. The geometry of the shank section 912 of this embodiment displaces less material of the workpiece 917 as compared to a fastener having a shank of constant diameter. Furthermore, the axial load applied to the fastener 902 during the fastener insertion process can be reduced as compared to a fastener having a shank of constant diameter. This advantageously reduces the likelihood of the workpiece 917 cracking as a result of the fastener insertion process. Since the likelihood of the workpiece 917 cracking is reduced, the fastener 917 advantageously may produce more robust joints. In addition, since less material is being displaced by the fastener 917, the resistance to deformation by the workpiece 917 is reduced relative to a fastener having a shank of constant diameter. Therefore, the time taken to insert the fastener into the workpiece 917 is reduced, where the axial load applied to the fastener 902 is equal to an axial load applied to a fastener having a shank of constant diameter. This therefore results in a more efficient fastener insertion process.

In some embodiments of the method of inserting the fastener, the method may comprise providing an aperture in the first workpiece layer. This may be particularly advantageous where the workpiece includes layers of different materials. In particular where the workpiece layer or layers to which the aperture or apertures is provided is not readily formable. Where the workpiece comprises one or more intermediate layers, the method may also comprise providing an aperture in at least one or more of the intermediate layers. The method may comprise providing an aperture in all of the intermediate layers. The aperture provided in the first workpiece layer may be referred to as a pre-hole. FIG. 17 depicts a joint 1038 resulting from such a method. As can be seen the first workpiece layer 1018 comprises an aperture 1090. The aperture 1090 may be provided using any known method, such as machining. In this embodiment, the second workpiece layer 1020 comprises the first surface 1034 of the workpiece 1017. The material from which the first workpiece layer 1018 is made may be, for example, a composite material. The material from which the first workpiece layer 1018 is made may be any other low ductility material.

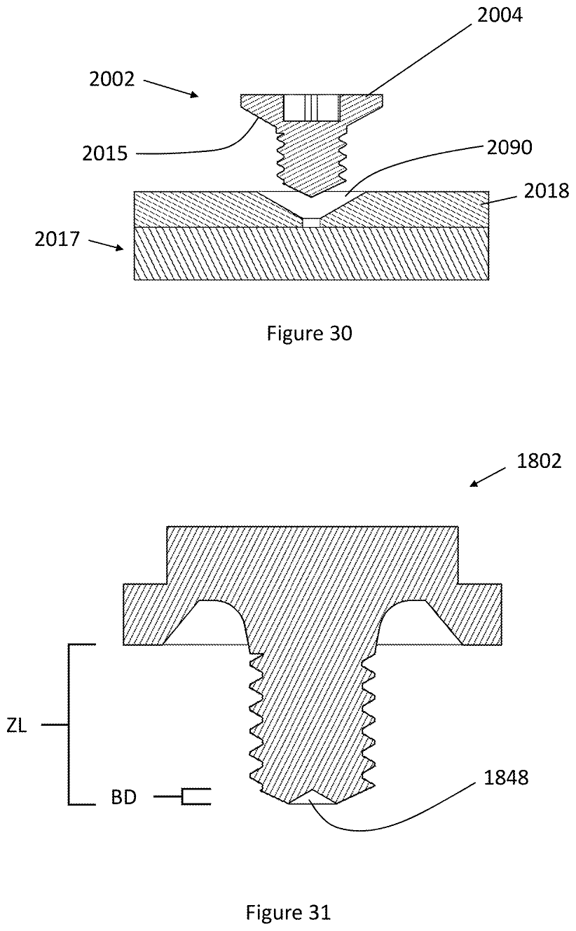

The shape of at least part of the aperture may correspond to the shape of the fastener. FIG. 29 shows an embodiment in which the shape of the aperture 1990 corresponds with the shape of the head 1904 of the fastener 1902. FIG. 30 also shows an embodiment in which the shape of the aperture 2090 corresponds with the shape of the head 2004 of the fastener 2002. In FIGS. 29 and 30, the shape of a part of the apertures 1990, 2090 each correspond with the shape of the underside 1915, 2015 of the head 1904, 2004 of the respective fastener 1902, 2002. The aperture may be sized with respect to the fastener that is to be inserted into the workpiece 1917, 2017. The size of the aperture 1990, 2090 with respect to the fastener 1902, 2002 may be chosen based on, for example, the material from which the workpiece 1917, 2017 is made. For example, a larger aperture may be used for harder and/or stronger workpieces. In FIG. 29, the size of the aperture 1990 corresponds with the size of the portion of the fastener 1902 that is to be received in the first workpiece layer 1918. That is to say, a ratio of the size of the aperture 1990 to the size of the portion of the fastener 1902 that is to be received in the first workpiece layer 1918 is 1:1. In FIG. 30, the size of the aperture 2090 is 25% of the size of the portion of the fastener 2002 that is to be received in the first workpiece layer 2018. That is to say, a ratio of the size of the aperture 2090 to the size of the portion of the fastener 2002 that is to be received in the first workpiece layer 2018 is 1:4. In general, the ratio of the size of the aperture to the size of portion of the fastener that is to be received by the first workpiece layer may be at least 1:4 and/or up to 1:1, and/or up to 2:1.

In some embodiments, where the method comprises providing an aperture in the first workpiece layer 1018, the method may additionally comprise centring the fastener 1002 with respect to the aperture 1090. Centring of the fastener 1002 with respect to the aperture 1090 may be performed with a machine vision system. The machine vision system may form a part of the fastener insertion apparatus (not shown in FIG. 17). The machine vision system is configured to identify the aperture 1090 and determine a centre of the aperture. This information is then provided to the fastener insertion apparatus. The fastener insertion apparatus then adjusts the position of the fastener 1002 such that the fastener is centred with respect to the aperture 1090. Following the centring of the fastener 1002 with respect to the aperture 1090, the longitudinal axis L of the fastener is generally coaxial with a centre axis (not shown in FIG. 17) of the aperture. The centre axis of the aperture 1090 being the axis that extends along a centre of the aperture.

Centring the fastener 1002 with respect to the aperture 1090 advantageously reduces the likelihood of the fastener contacting a surface of the aperture during the fastener insertion process. Contact between the fastener 1002 and the surface of the aperture is undesirable because this can result in an improperly inserted fastener. By centring the fastener 1002, consistently formed joints are provided.

The method for inserting a fastener into the workpiece 1017 is otherwise identical to the method described above. Providing the aperture 1090 allows a fastener to be used to connect a first workpiece layer 1018 to a second workpiece layer 1020 where the first workpiece layer 1018 is made from a material that is not readily formable.

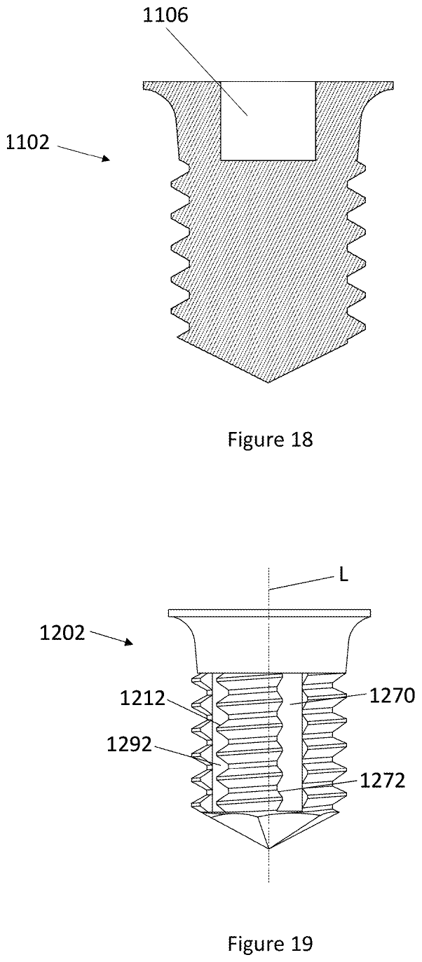

In some embodiments, the drive geometry of the fastener may be an internal drive geometry. FIG. 18 depicts a fastener 1102 in which the drive geometry 1106 is an internal drive geometry. This allows the fastener 1102, following insertion into a workpiece (not shown in FIG. 18) to be generally flush with the first surface of the workpiece. An internal drive geometry may be hexagonal, or may have some other suitable shape (the same applies to an external drive geometry) Because the drive geometry 1106 is an internal drive geometry, the diameter of the head 1104 is reduced compared to a fastener having an external drive geometry. This allows the fastener 1102 to be used on narrower workpieces (not shown in FIG. 18), as compared to a fastener having an external drive geometry, without the head 1104 overhanging from the workpiece. This drive geometry, and other internal drive geometries, may be used in combination with other fastener embodiments.

In some embodiments, the fastener may comprise one or more retaining features. FIG. 19 shows a further embodiment of a fastener 1202 that comprises one or more retaining features. In this embodiment, the one or more retaining features are in the form of a plurality of recesses 1292 (only one of which is labelled in FIG. 19). In some embodiments, only at least one recess need be provided. In the depicted embodiment, the plurality of recesses 1292 comprises four recesses. In other embodiments, the plurality of recesses 1292 may comprise any suitable number of recesses. For example, the plurality of recesses 1292 may comprise at least two recess. In some embodiments, the plurality of recess 1292 may comprise equal to or less than 4 recesses. In some embodiments, the plurality of recess 1292 may comprise equal to or less than 6 recesses. The recesses 1292 extend into the shank section 1212 of the fastener 1202. The recesses 1292 extend towards the longitudinal axis L of the fastener 1202. The plurality of recesses 1292 extend in a direction that is parallel to the longitudinal axis L of the fastener 1202. In some embodiments, the plurality of recesses 1292 may extend at least partially around the longitudinal axis L of the fastener 1202.

The plurality of recesses 1292 extend along the entire length of the shank section 1212. In some embodiments, the plurality of recesses may extend part way along the shank section 1212. In some embodiments, the plurality of recesses 1292 may only extend along the first shank portion 1270. In some embodiments, the plurality of recesses 1292 may only extend along the second shank portion 1272. The plurality of recesses 1292 may be referred to as vertical thread gaps. Because of the plurality of recesses 1292, the fastener 1202 cannot be removed from a workpiece into which the fastener is inserted. This is because of the interference between the plurality of recesses and the material of the workpiece.

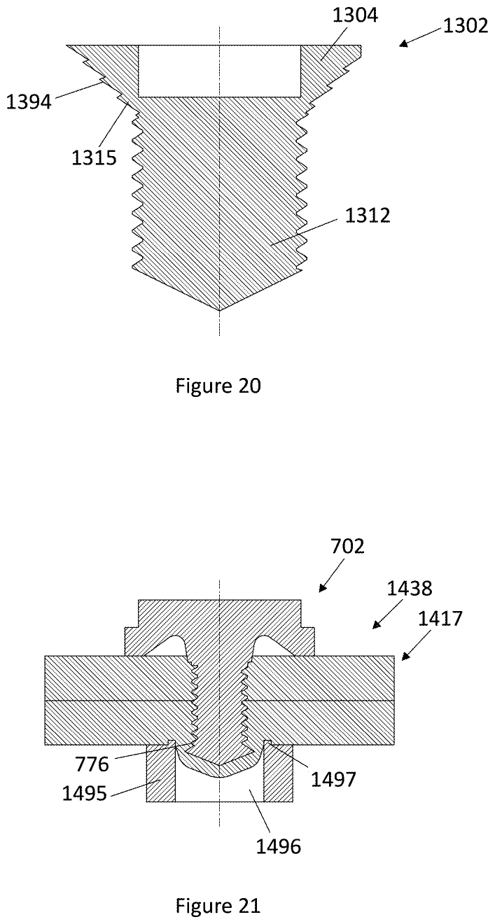

In some embodiments, the fastener may comprise one or more secondary securing features. The one or more secondary securing features may be in the form of one or more surface irregularities. FIG. 20 shows an embodiment of a fastener 1302 that comprises one or more secondary securing features. In the depicted embodiment, the one or more secondary securing features are in the form of a thread 1394 that is provided to the underside 1315 of the head 1304 of the fastener 1302. The direction of the thread 1394 is the same as the direction of the thread of the shank section 1312. In some embodiments, the direction of the thread 1394 may be opposed to the direction of the thread of the shank section 1312. In other embodiments, the one or more retaining features may be in the form of any other type of surface irregularity, such as protrusions and/or ribs. When inserted into a workpiece (not shown in FIG. 20), the thread 1394 engages the workpiece, thereby further securing the fastener 1302 to the workpiece. The one or more secondary securing features advantageously reduce the likelihood of the fastener 1302 becoming loose when subjected to vibrational loading. Therefore, the one or more secondary securing features advantageously produce a more robust joint.

In some embodiments, where a die is provided during the fastener insertion process, the die may be a ring die. Such an embodiment is shown in FIG. 21. In FIG. 21, the fastener 702 is secured to the workpiece 1417. However, any of the fasteners described in this document may be used in combination with a ring die. FIG. 21 shows a joint 1438 in combination with a ring die 1495. The ring die 1495 comprises a cavity 1496. The ring die 1495 comprises a projection 1497. The projection 1497 is ring-shaped, and is provided as a lip round the cavity 1496. During the fastener insertion process, the projection 1497 urges the material of the workpiece 1417 into the threads of the fastener 702. In addition, where the fastener comprises an undercut 776, the projection 1497 urges the material of the workpiece 1417 into the undercut 776 of the fastener 702. Advantageously, this improves the engagement between the fastener 702 and the material of the workpiece 1417. Improved engagement between the fastener 702 and the material of the workpiece 1417 advantageously improves the strength of the connection between the fastener 702 and the workpiece 1417.

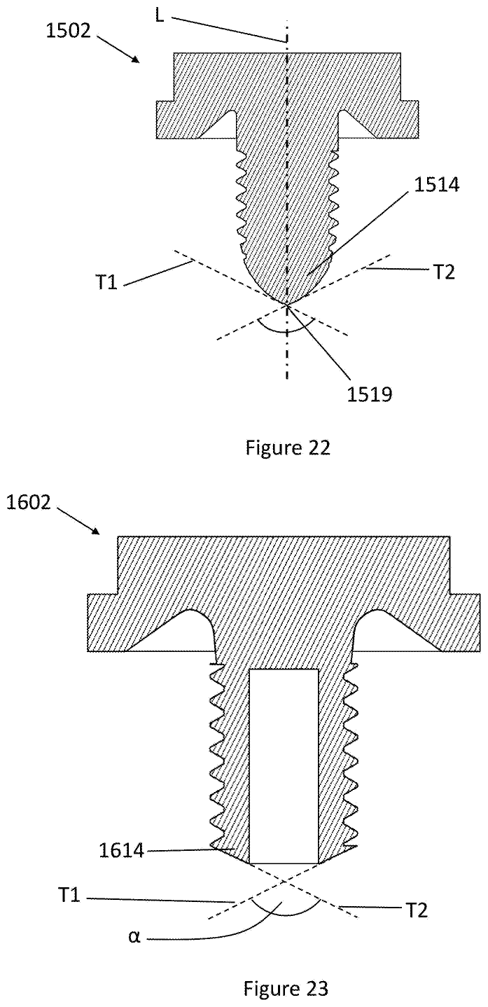

As discussed above, in some embodiments, the tip section of the shank may be radiused. Such an embodiment is shown in FIG. 22. As can be seen, the tip section 1514 is radiused. The tip 1519 of the tip section 1514 is pointed. In some embodiments, the tip 1519 of the tip section 1514 may be radiused. The tip section 1514 defines a tip angle α. The tip angle α is the angle between a first tangent line T1 and a second tangent line T2. The first tangent line T1 and the second tangent line T2 extend through diametrically opposed points of the tip section 1514. The point through which the first tangent line T1 extends is at the same position along the longitudinal axis L of the fastener 1502 as the point through which the second tangent line T2 extends. The position of the points through which the first and second tangent lines T1, T2 extend are such that the angle between the first and second tangent lines T1, T2 is a maximum value.

As discussed above, the fastener may be provided with a bore that is entirely cylindrical. Such an embodiment is shown in FIG. 23. As can be seen, the entirety of the bore 1648 of the fastener 1602 is cylindrical. The tip angle α of the tip section 1614 is the angle between diametrically opposed points of the tip section 1614. The tip angle α in FIG. 23 is measured between a first tangent line T1 and a second tangent line T2. The first tangent line T1 and the second tangent line T2 extend through diametrically opposed points of the tip section 1614.

FIG. 31 shows a further embodiment of a fastener 1802. The fastener 1802 comprises a bore 1848. The bore 1848 is conical. In other, non-depicted, embodiments, the bore 1848 may be frustoconical, cylindrical, or any other suitable shape. A ratio of the bore depth BD to the shank length ZL may be up to 0.25. That is to say, the bore depth BD may be up to 25% of the shank length ZL. In some embodiments, the bore depth may be up to 10% of the shank length ZL. The bore depth BD may be chosen based on, for example, the hardness of the workpiece into which the fastener 1802 is to be inserted, the strength of the workpiece, and/or the thickness of the workpiece. A shallower bore depth BD as a ratio of the shank length ZL may be particularly suited for harder, stronger, and/or thinner workpieces. The provision of a bore results in a ring-shaped initial contact area between the fastener 1802 and the workpiece. This increases the velocity of the portion of the fastener 1802 contacting the workpiece as compared a point contact area. Increasing this velocity increases the heat supplied to the workpiece by the fastener 1802, which decreases the time taken to heat the workpiece.

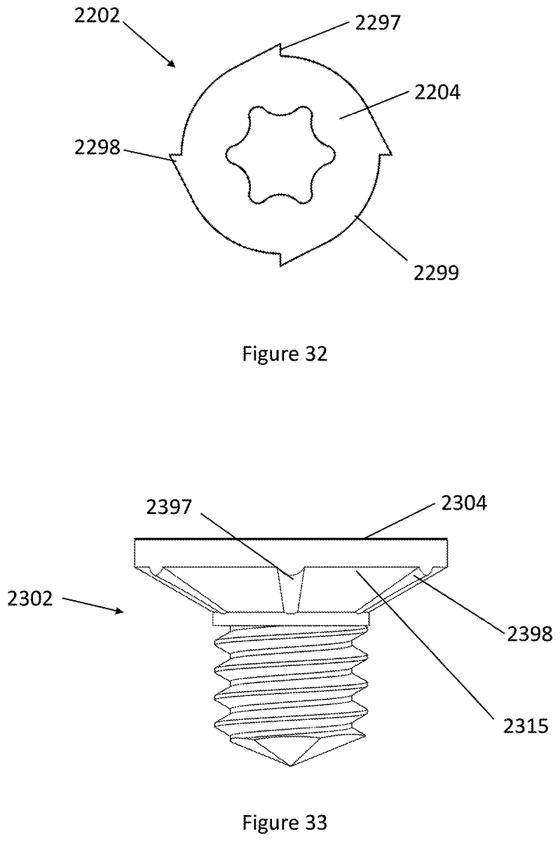

In some embodiments, the fastener may be able to remove excess, or extruded, workpiece material. When inserting a fastener into a workpiece, workpiece material may be extruded from the workpiece in a direction opposed to the direction of insertion of the fastener. When extruded, the material of the workpiece is in a softened state, but is not in a liquid state. This excess material is undesirable because it is susceptible to corrosion, which can lead to joint failure. FIG. 32 shows an embodiment of a fastener 2202 that is able to remove excess workpiece material. In this embodiment, the head 2204 of the fastener 2202 is provided with a plurality of cutting edges 2297 (only one of which is labelled in FIG. 32). Generally, the cutting edge(s) need not be sharp because the extruded material is softened when it is to be cut by the cutting edge(s) of the fastener. The cutting edges 2297 each form a part of a respective tooth 2298 (only one of which is labelled in FIG. 32). The teeth 2298 extend from the circumferential periphery 2299 of the head 2204. The plurality of teeth 2298 comprise four teeth 2298, and so four cutting edges 2297 are provided. However, in some embodiments, the head 2204 may comprise at least one tooth, and/or up to six teeth, each being provided with a respective cutting edge. FIG. 33 shows an alternative embodiment of a fastener 2302 that includes a plurality of cutting edges 2397. The cutting edges 2397 each form a part of a respective rib of a plurality of ribs 2398. The ribs 2398 are provided to the underside 2315 of the head 2304. The plurality of ribs 2398 comprises five ribs, and so five cutting edges 2397 are provided. However, in some embodiments, the head 2304 may comprise at least one rib, and/or up to six ribs, each being provided with a respective cutting edge. The number of teeth 2298 or ribs 2398, and therefore the number of cutting edges 2297, 2397, may be chosen based on, for example, the hardness of the material from which the workpiece into which the fastener 2202 is to be inserted.

Where the cutting edges 2297, 2397 are present, which may be the case for any of the embodiments disclosed herein, the method of inserting the fastener into a workpiece may further include cutting extruded, or excess, material from the workpiece using the cutting edge(s). Cutting of the excess workpiece material may take place after the fastener has been threaded into the workpiece. However, the thread need not be fully formed before cutting of the excess workpiece material begins.

In FIG. 33, the ribs of the plurality of ribs 2398 are provided with a radius. The ribs of the plurality of ribs are generally rounded. The ribs 2398 are able to cut extruded material from the workpiece during a fastener insertion process because the extruded material is softened. In some, non-depicted, embodiments, the ribs of the plurality of ribs 2398 may each define a respective apex. Where provided, the apexes define the cutting edge of each rib.

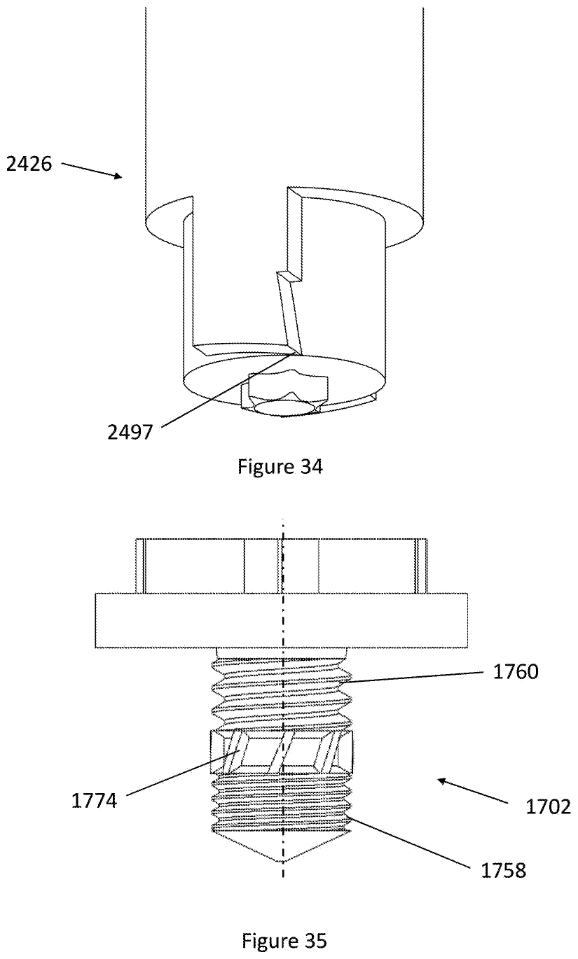

In some embodiments, the nosepiece of the insertion apparatus used to insert any of the above fasteners may be able to remove excess workpiece material. FIG. 34 shows an embodiment of such a nosepiece 2426. The nose comprises a plurality of cutting edges 2497 (only one of which is visible in FIG. 34). The plurality of cutting edges 2497 comprise two cutting edges. The two cutting edges are diametrically opposed to one another. In some embodiments, the nosepiece 2426 may comprise at least one, and/or up to four cutting edges.

Although numerous specific embodiments of the present invention have been described above, features of each embodiment can be combined. For example, the fastener may comprise a bore, as for the fastener 302, and a stud, as for the fastener 202. FIG. 35 shows an embodiment of a fastener 1702 that combines features of the embodiments described above. The fastener 1702 comprises a first thread portion 1658 and a second thread portion 1760. The fastener 1702 further comprises retaining features in the form of a plurality of protrusions 1774. The plurality of protrusions are disposed between the first thread portion 1558 and the second thread portion 1760. The pitch distance of the thread of the first thread portion 1758 is less than the pitch distance of the thread of the second thread portion 1760.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

1. A hole forming and thread forming fastener comprising:
a head and a shank that defines a longitudinal axis, the shank comprising a shank section and a tip section, wherein the shank section extends from the head and the tip section extends from the shank section and is opposed to the head;
wherein at least part of the shank section is threaded; and
wherein the tip section is at least partially tapered and defines a tip angle, the tip angle being at least 50 degrees.

2. The hole forming and thread forming fastener of claim 1, wherein the tip angle is at least 70 degrees.

3. The hole forming and thread forming fastener of claim 1, wherein the tip section defines a tip section length and the shank section defines a shank section diameter, and where a ratio of the tip section length to the shank section diameter is less than or equal to 0.6.

4. The hole forming and thread forming fastener of claim 1, wherein the tip angle is less than or equal to 160 degrees; and/or wherein the tip angle is at least 125 degrees, and less than or equal to 135 degrees.

5. (canceled)

6. The hole forming and thread forming fastener of claim 1, wherein the shank section comprises a first shank portion that adjoins the head and a second shank portion that adjoins the tip section.

7. The hole forming and thread forming fastener of claim 6, wherein the first shank portion is not threaded and the second shank portion is threaded; and/or wherein,
the first shank portion comprises one or more retaining features, and wherein, in use, the one or more retaining features engage a workpiece into which the hole forming and thread forming fastener is inserted; and/or wherein
the diameter of the first shank portion is greater than the diameter of the second shank portion.

8. (canceled)

9. (canceled)

10. The hole forming and thread forming fastener of claim 1, wherein the head defines an undercut; and/or wherein
the hole forming and thread forming fastener further comprises a threaded stud that extends from a side of the head that is opposed to the underside; and/or wherein
the tip section defines an undercut that is disposed adjacent the shank section; and/or wherein
the pitch diameter of the thread of the shank section is constant along at least 90% of the length of the shank section.

11-13. (canceled)

14. A method of inserting a fastener into a workpiece, the method comprising:
providing a fastener, the fastener
a head and a shank that defines a longitudinal axis, the shank comprising a shank section and a tip section, wherein the shank section extends from the head and the tip section extends from the shank section and is opposed to the head;
wherein at least part of the shank section is threaded; and
wherein the tip section is at least partially tapered and defines a tip angle, the tip angle being at least 50 degrees;
providing a workpiece, the workpiece comprising a first surface and a second surface, the second surface being opposed to the first surface;
rotating the fastener about the longitudinal axis of the fastener and bringing the fastener into contact with the first surface of the workpiece so as to heat the workpiece;
threading the fastener into the workpiece by moving the fastener and the workpiece relative to one another in a direction that is parallel to the longitudinal axis of the fastener such that the tip section of the fastener penetrates the first surface;
wherein the fastener does not penetrate the second surface of the workpiece.

15. The method of claim 14, wherein threading the fastener into the workpiece comprises forming a thread in the workpiece with the fastener.

16. The method of claim 14, further comprising providing a die, and wherein, while the fastener is being threaded into the workpiece, the second surface engages the die; wherein optionally
the die comprises a die recess, and wherein while the fastener is being threaded into the workpiece, the second surface of the workpiece deforms into the die recess; wherein optionally
the die recess defines a die recess volume, and wherein a volume of workpiece material is displaced while the fastener is being threaded into the workpiece, and wherein the die volume is equal to or greater than the volume of workpiece material displaced.

17. (canceled)

18. (canceled)

19. The method of claim 14, wherein the workpiece comprises only a single workpiece layer.

20. The method of claim 14, wherein the workpiece comprises a first layer and a second layer.

21. The method of claim 20, wherein at least one of the layers of the workpiece is made from a metallic material, optionally wherein at least one of the layers of the workpiece is made from aluminium; and/or wherein
the first workpiece layer comprises an aperture through which the fastener passes before contacting the workpiece; wherein optionally
the first workpiece layer is formed of a composite material; and/or wherein
the fastener further comprises a threaded stud that extends from a side of the head that is opposed to the shank section of the shank, and wherein the method further comprises securing a component to the threaded stud.

22-24. (canceled)

25. The method of claim 14, wherein the rate at which the fastener is rotated relative to the workpiece is reduced at least once while the fastener is being threaded into the workpiece; and/or wherein
following threading the fastener into the workpiece, the second surface of the workpiece comprises a protrusion in which at least part of the tip section of the shank of the fastener is received.

26. The method of claim 14, wherein the workpiece comprises a first layer and a second layer and wherein the reduction of the rate at which the fastener is rotated relative to the workpiece occurs while the tip section is disposed in the second workpiece layer.

27. (canceled)

28. A joint comprising:
a workpiece comprising a first surface and a second surface;
a fastener comprising:
a head and a shank that defines a longitudinal axis, the shank comprising a shank section and a tip section, wherein the shank section extends from the head and the tip section extends from the shank section and is opposed to the head;
wherein at least part of the shank section is threaded; and
wherein the tip section is at least partially tapered and defines a tip angle, the tip angle being at least 50 degrees;
wherein the fastener extends through the first surface and does not penetrate the second surface.

29. The joint of claim 28, wherein the workpiece comprises a first workpiece layer that comprises the first surface and a second workpiece layer that comprises the second surface.

30. The joint of claim 29, wherein the first workpiece layer comprises an aperture through which the thread forming and hole forming fastener extends; and/or wherein
the first workpiece layer is formed of a composite material.

31. (canceled)

32. The joint of claim 28, wherein the workpiece comprises only a single workpiece layer.

33. The joint of claim 28, wherein the thread forming and hole forming fastener further comprises a threaded stud that extends from a side of the head that is opposed to the shank section; and/or wherein
at least one of the workpiece layers is made from a metallic material, optionally wherein at least one of the layers of the workpiece is made from aluminium; and/or wherein
the head of the thread forming and hole forming fastener is disposed proud of the workpiece, or wherein the head of the thread forming and hole forming fastener is disposed substantially flush with the workpiece; and/or wherein
the second surface comprises a protrusion in which the tip section of the fastener is at least partially received.

34-36. (canceled)
